(19) United States
(12) Patent Application Publication
(10) Pub. No.: US 2004/0135788 A1
(43) Pub. Date: Jul. 15, 2004

(54) Image processing system

(76) Inventors: Colin Bruce Davidson, London (GB); Charles Stephen Wiles, London (GB); Mark Jonathan Williams, London (GB); Gary Michael Sleet, London (GB)

Correspondence Address: FINNEGAN, HENDERSON, FARABOW, GARRETT & DUNNER, LLP, 1300 I STREET, NW, WASHINGTON, DC, 20005, US

(21) Appl. No.: 10/451,397

(22) PCT Filed: Dec. 21, 2001
(86) PCT No.: PCT/GB01/05779

(30) Foreign Application Priority Data
Dec. 22, 2000 (GB) 0031511.9
Aug. 10, 2001 (GB) 0119598.1

(51) Int. Cl. G06T 1/60

(52) U.S. Cl. 345/530

(57) ABSTRACT

An image processing system is provided which receives image data of a user and generates a set of appearance parameters representative of the appearance of the user in the received images. These appearance parameters may then be transformed either to change the identity of the user in the images or to change the resolution of the image of the user. Synthesised images of the user can then be generated from the transformed parameters. The system can be used as a stand alone image processing system or may form part of an image transmission and reception system. It may also be used for streaming data over limited bandwidth communication channels such as the Internet. A system is also provided for animating a single image from a set of image deviations obtained from a source video sequence. A system for changing the lighting conditions in the single image is also provided.

The present invention relates to a method and apparatus for graphics and image processing. The invention has particular, although not exclusive, relevance to the image processing of a sequence of source images to generate a sequence of target images. The invention has applications in computer animation and in moving pictures.

Realistic facial synthesis is a key area of research in computer graphics. The applications of facial animation include computer games, video conferencing and character animation for films and advertising. However, realistic facial animation is difficult to achieve because the human face is an extremely complex geometric form.

The applicant has proposed in their earlier International application WO 00/17820 a system for processing a source video sequence of an actor or the like acting out a scene to generate a target video sequence of a different actor or the like acting out the scene. The system uses a parametric model to model the appearance of the two actors. A set of difference parameters are calculated which are representative of the difference in appearance between the two actors. Appearance parameters for the first actor are then generated for each frame of the source video sequence. The predetermined difference parameters are then subtracted from the source appearance parameters in order to generate appearance parameters for the second actor. These are then converted back into image data and recombined with the source video sequence to generate the target video sequence.

According to one aspect, the present invention provides an alternative system for generating a target video sequence from a source video sequence.

Exemplary embodiments of the present invention will now be described with reference to the accompanying in which:

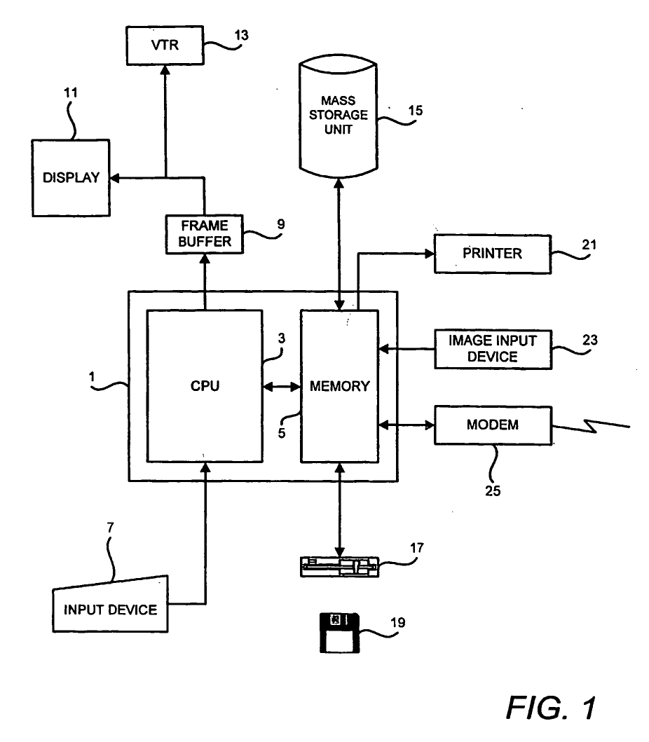

FIG. 1 is a schematic block diagram illustrating a general arrangement of a computer system which is programmed to implement the present invention;

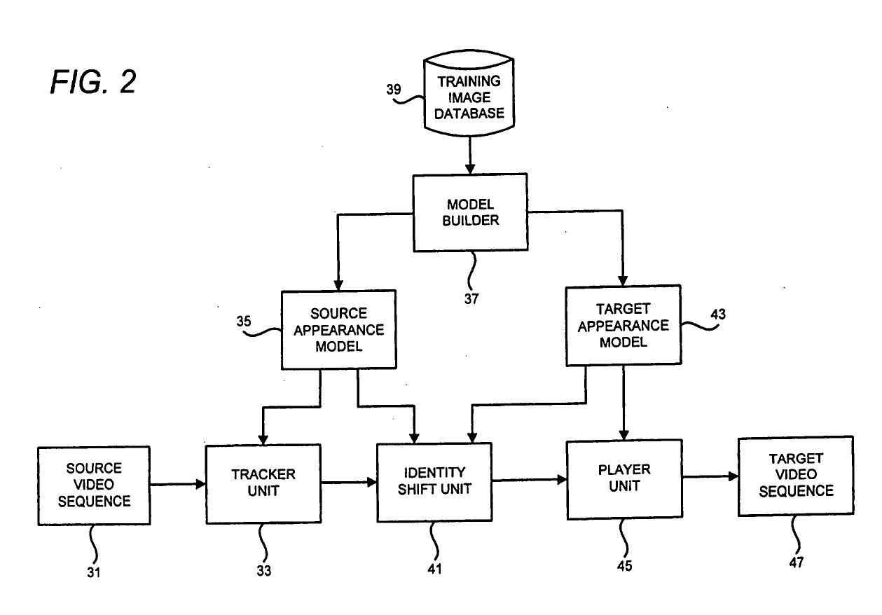

FIG. 2 is block diagram of an image processing system which allows the identity shifting of a source image into a target image;

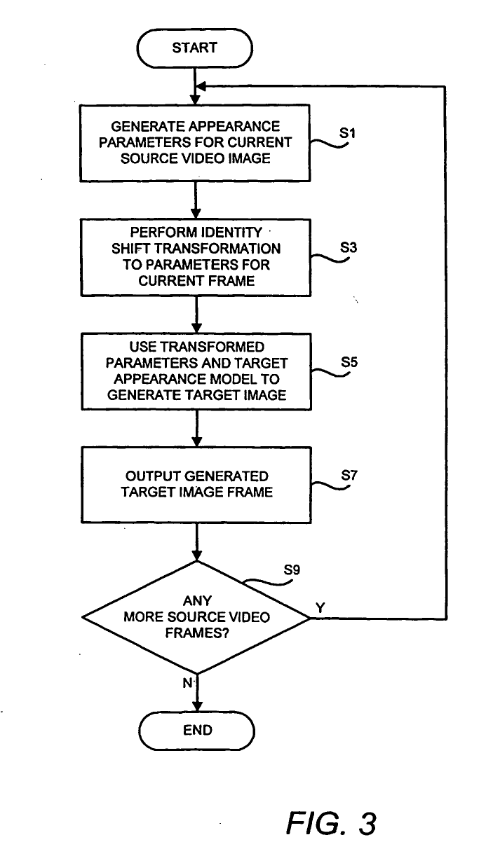

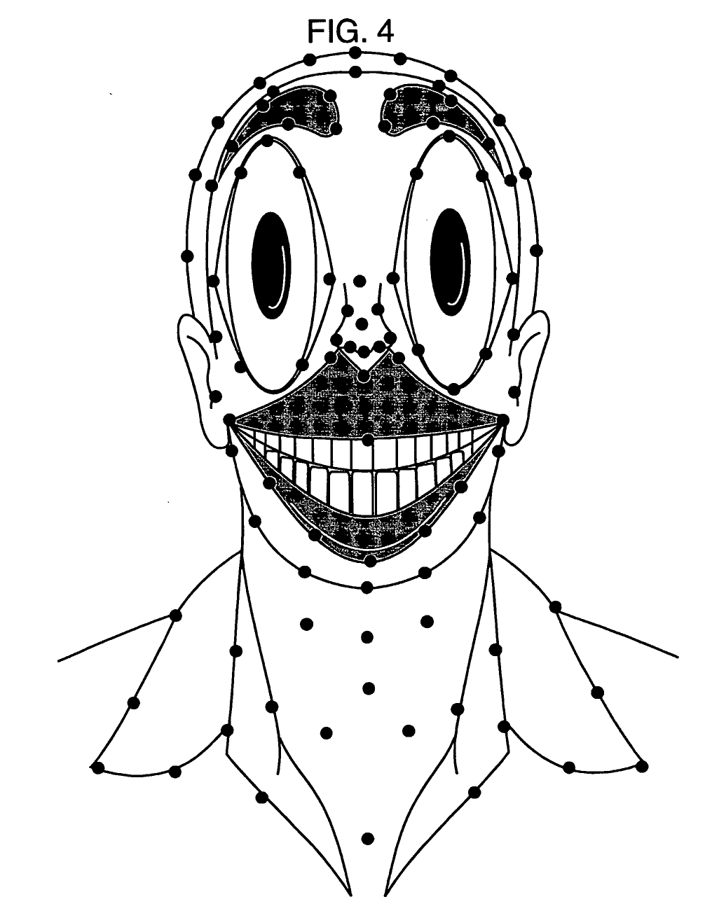

FIG. 3 is a flow chart illustrating the processing steps performed by the image processing system shown in FIG. 2;

FIG. 4 is a schematic illustration of a reference shape into which training images are warped before pixel sampling;

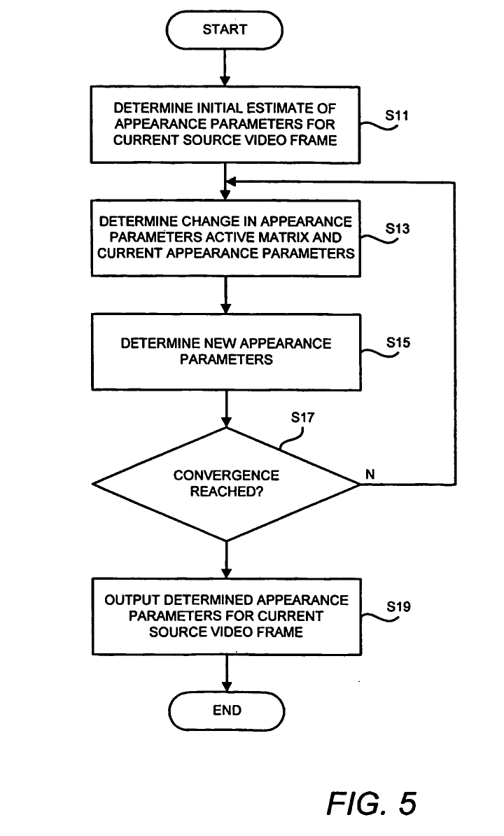

FIG. 5 is a flow diagram illustrating the processing steps involved in tracking a subject within a video sequence and generating appearance parameters for the tracked subject;

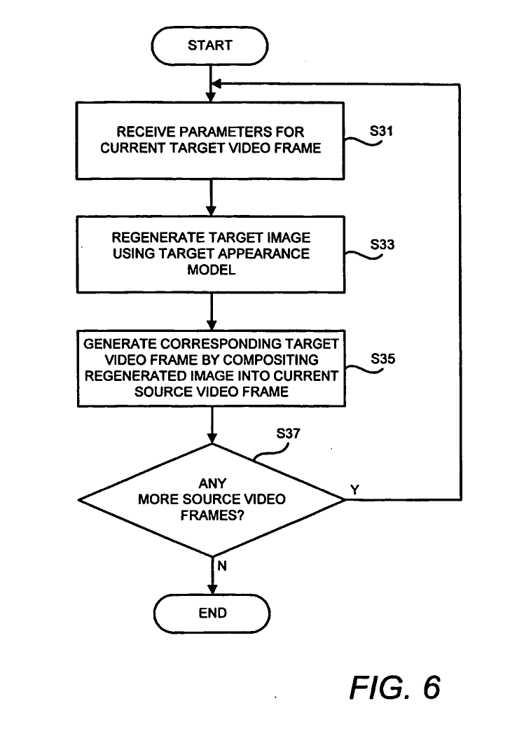

FIG. 6 is a flow chart illustrating the processing steps performed by a player unit of the image processing system shown in FIG. 2;

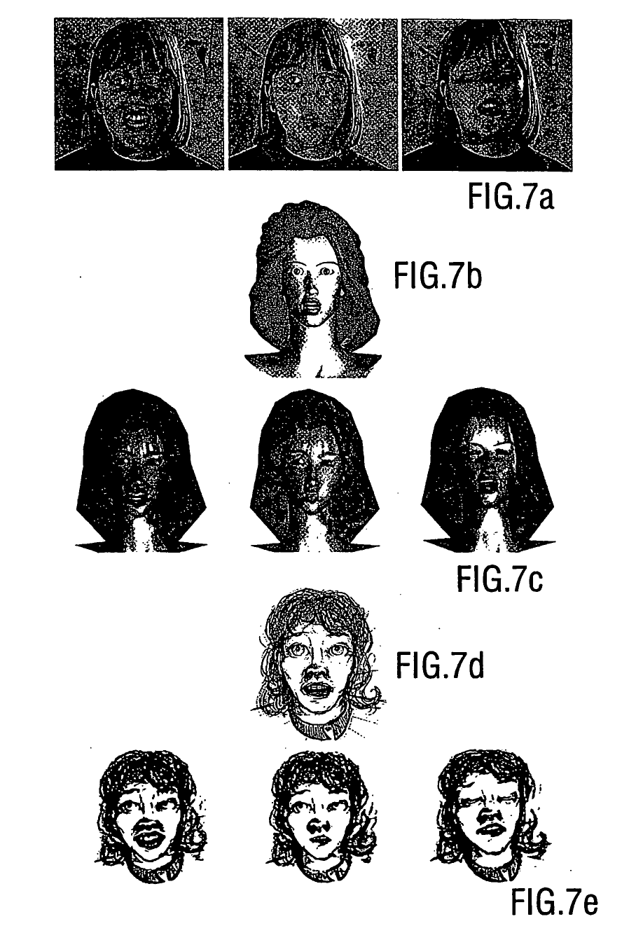

FIG. 7a shows three frames of an example source video sequence which is applied to the image processing system shown in FIG. 2;

FIG. 7b is an image corresponding to a target appearance model used to generate the target video sequence by the system shown in FIG. 2;

FIG. 7c shows a corresponding three frames from the target video sequence generated by the image processing system shown in FIG. 2 from the three frames of the source video sequence shown in FIG. 7a with the target appearance model corresponding to the image shown in FIG. 7b;

FIG. 7d shows an example image corresponding to a second target appearance model used in the image processing system shown in FIG. 2;

FIG. 7e shows the corresponding three frames from the target video sequence generated by the image processing system shown in FIG. 2 when the three frames of the source video sequence shown in FIG. 7a are input to the image processing system with the target appearance model corresponding to the image shown in FIG. 7d;

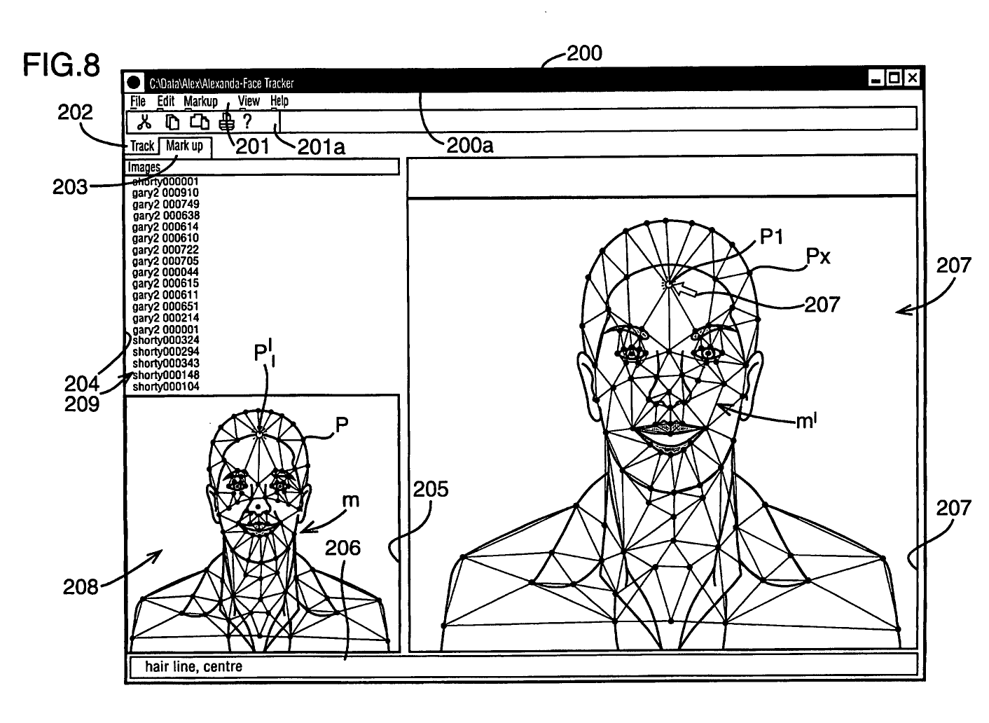

FIG. 8 shows a display screen presented to a user in one mode of a model builder interface;

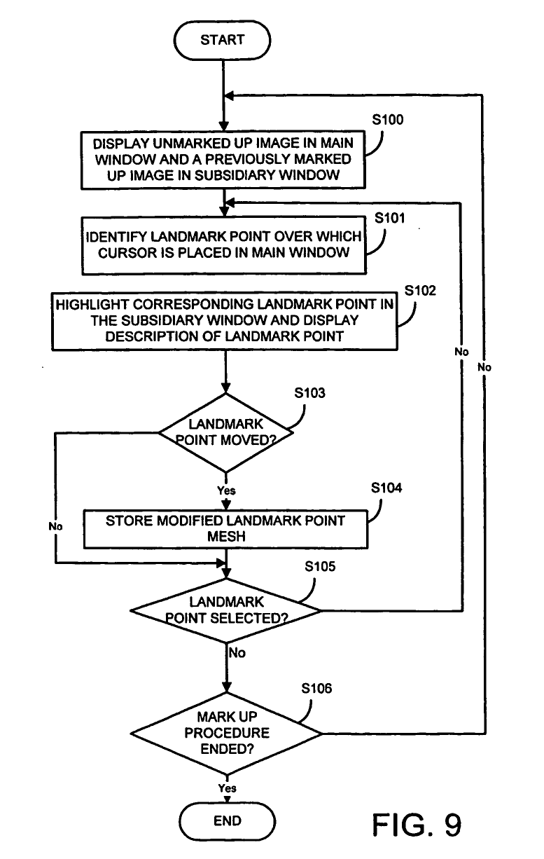

FIG. 9 shows a flow chart for illustrating processing steps performed by the model builder in the interface mode shown in FIG. 8;

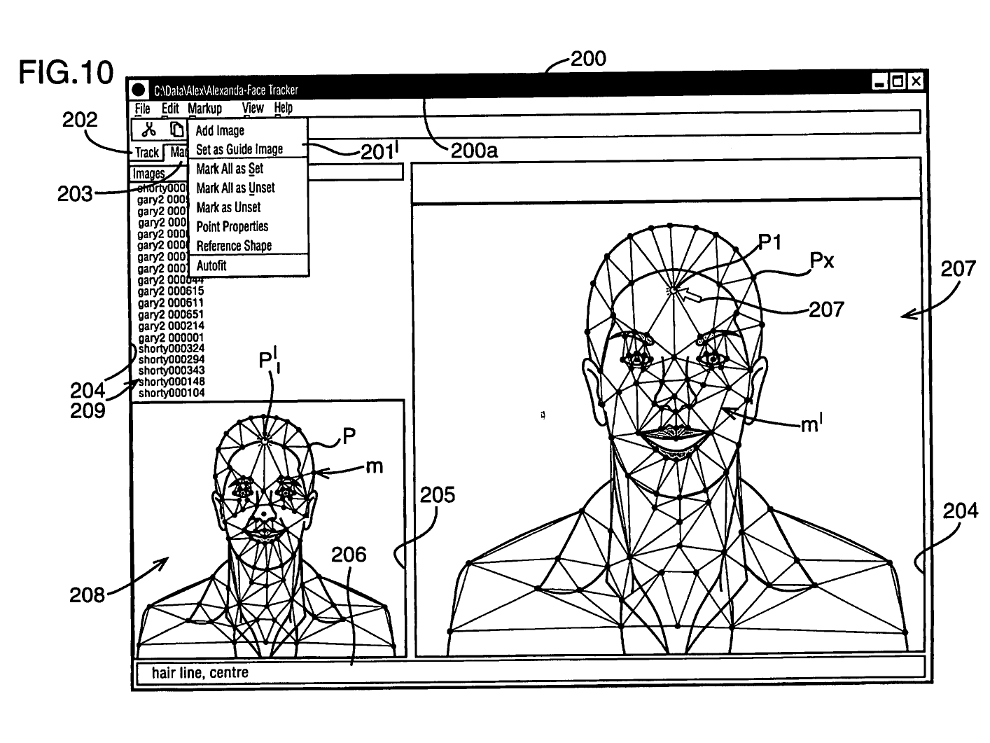

FIG. 10 shows the display screen shown in FIG. 8 with a drop down menu selected;

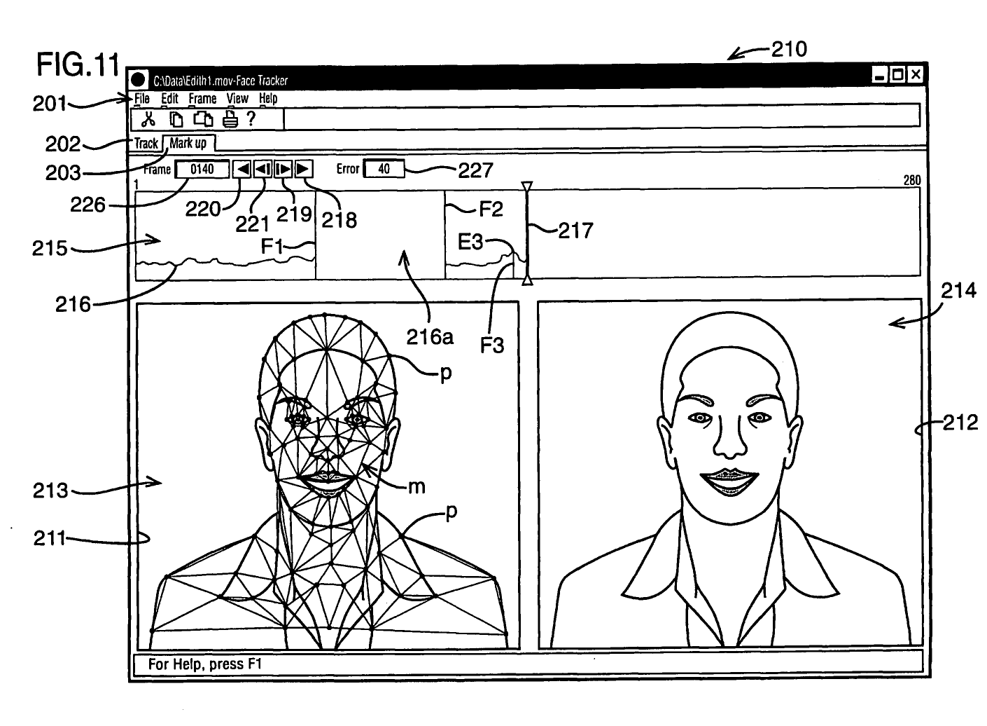

FIG. 11 shows a display screen presented to a user in another mode of the model builder interface;

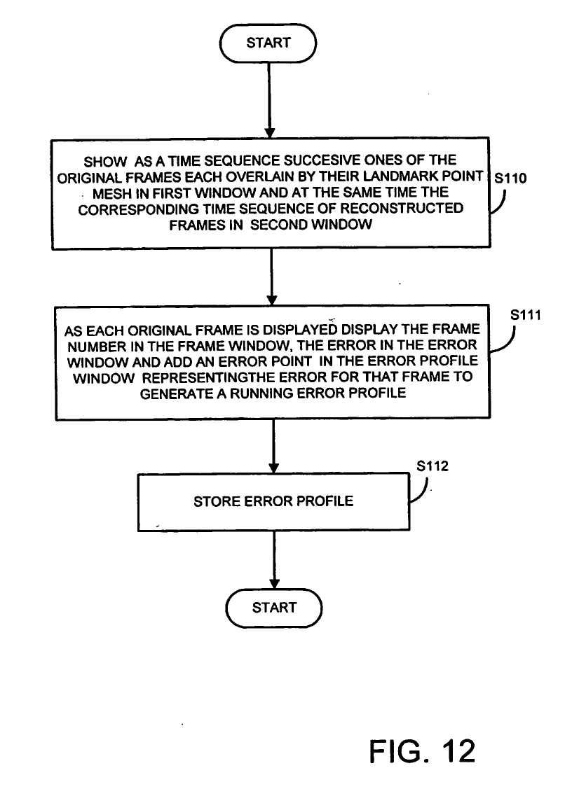

FIG. 12 shows a flow chart illustrating processing steps carried out to generate the display shown in FIG. 11;

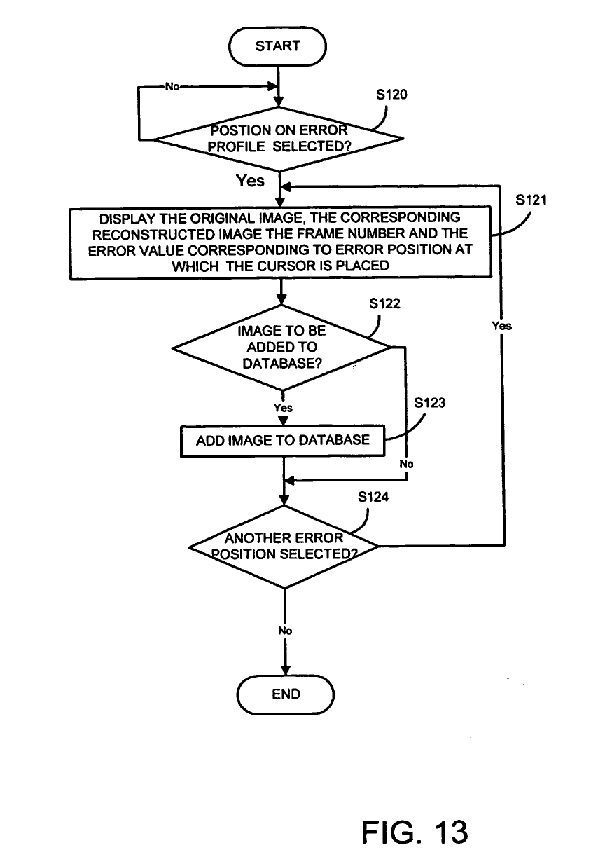

FIG. 13 shows a flow chart illustrating processing steps carried out when a user selects a position on an error profile shown by the display screen shown in FIG. 11;

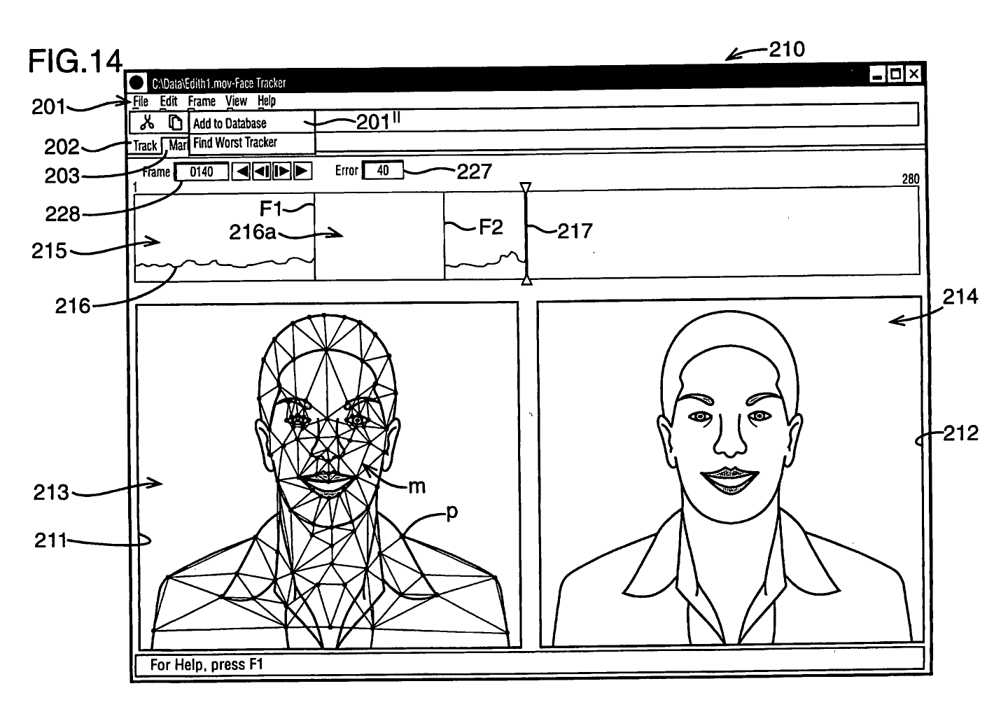

FIG. 14 shows the display screen shown in FIG. 11 with a drop down menu selected;

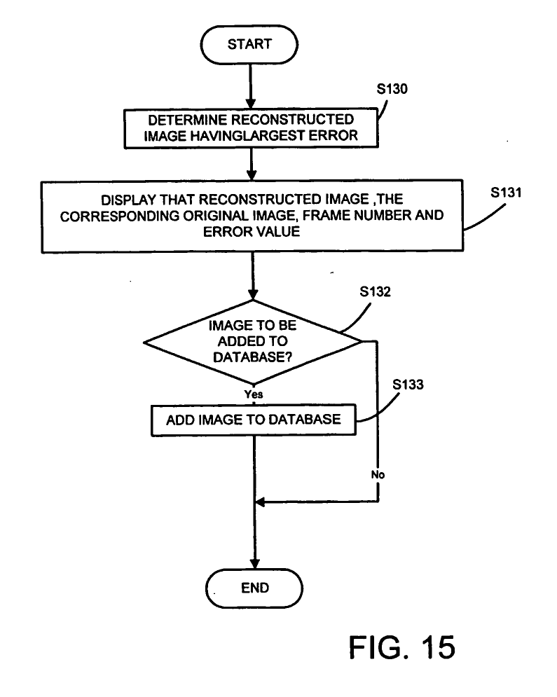

FIG. 15 shows a flow chart illustrating processing steps performed when a find worst tracked option shown in FIG. 14 is selected;

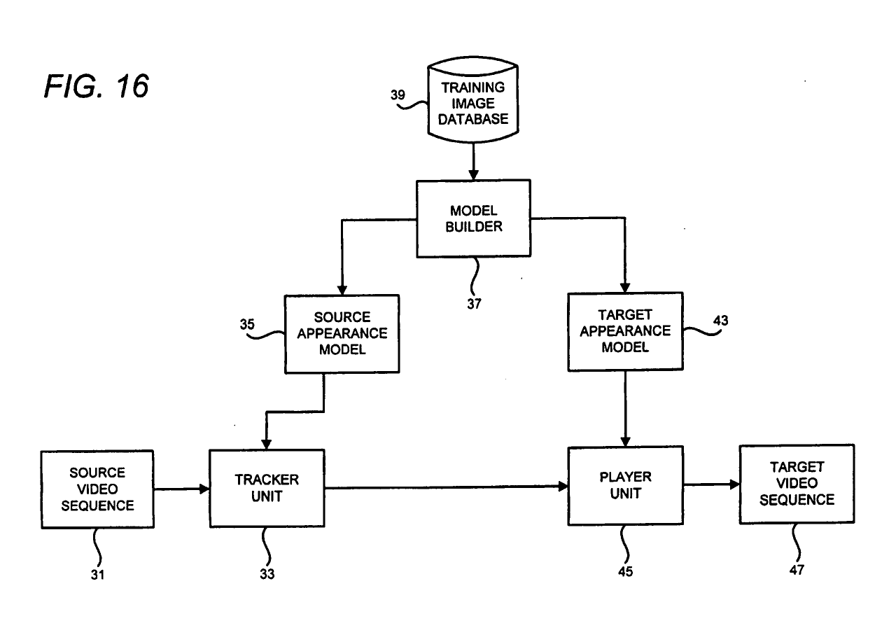

FIG. 16 is a block diagram of an image processing system for animating a single image of a second actor from a video sequence of a first actor;

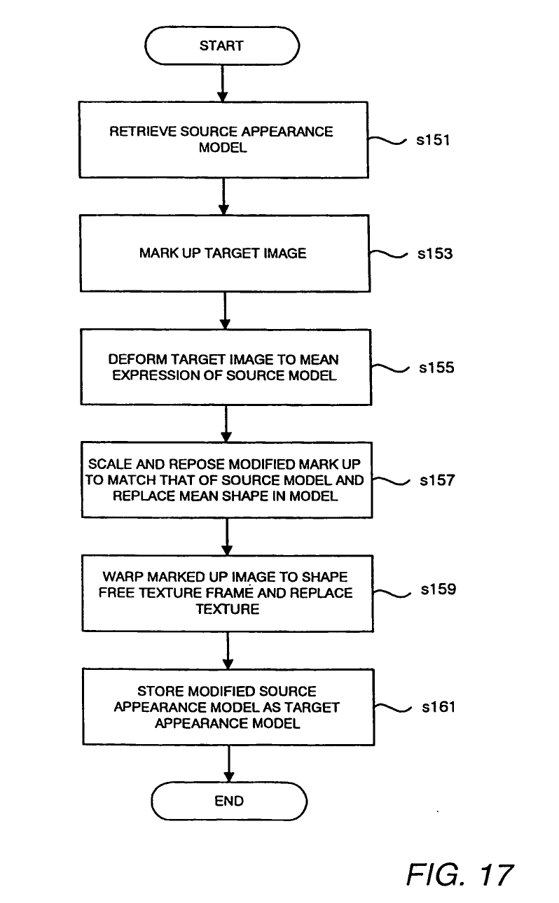

FIG. 17 is a flowchart illustrating the processing steps performed in order to generate a target appearance model which is used to generate the animated target video sequence;

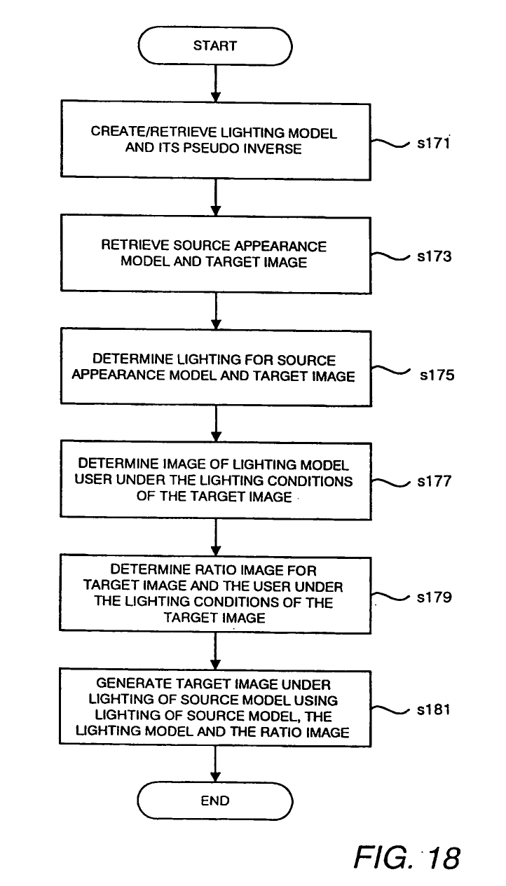

FIG. 18 is a flowchart illustrating the processing steps performed for changing the lighting conditions of an object in an image;

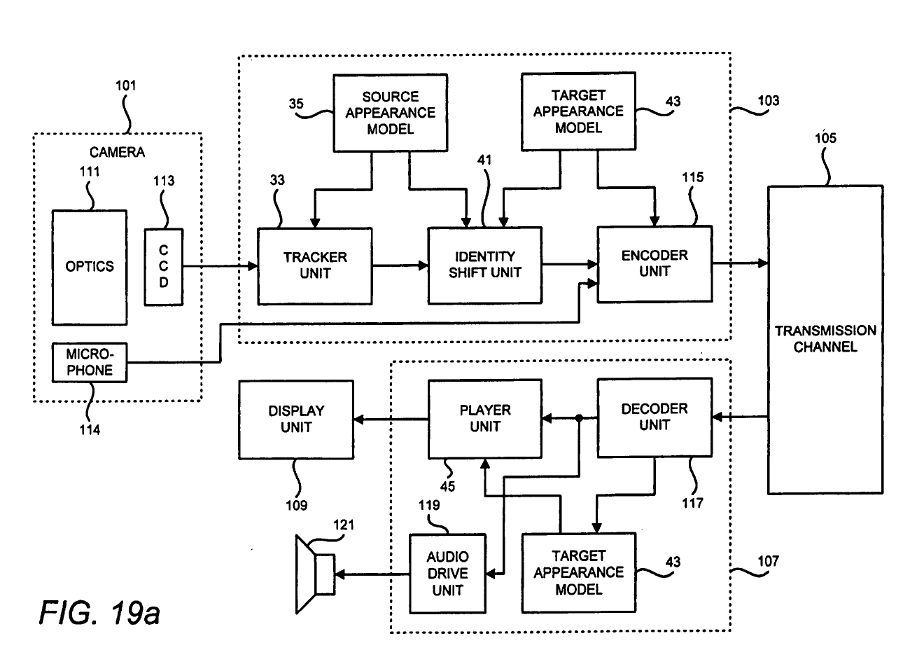

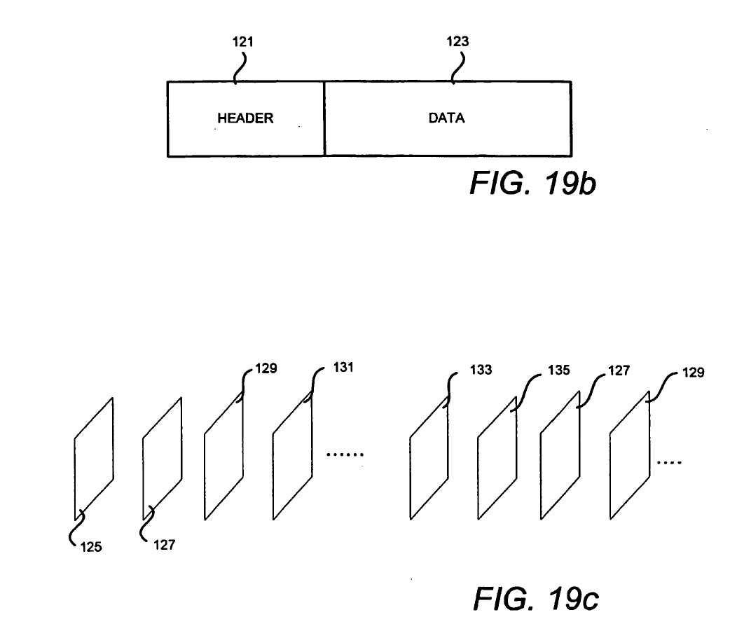

FIG. 19a illustrates an image transmission system;

FIG. 19b is a schematic diagram illustrating the form of the data packets used in the image transmission system shown in FIG. 19a;

FIG. 19c schematically illustrates a stream of data packets transmitted in the image transmission system shown in FIG. 19a;

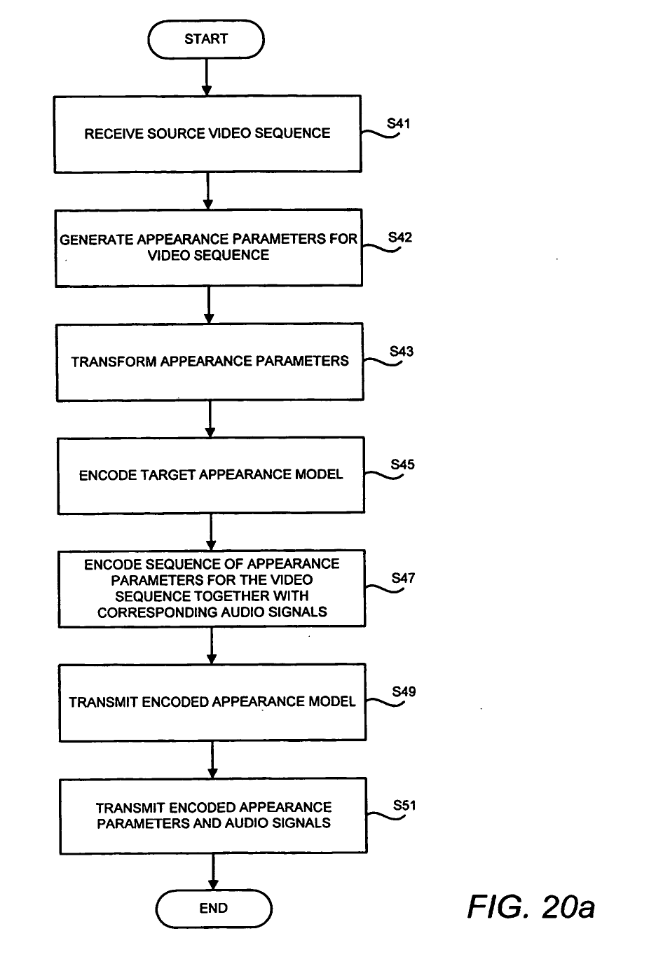

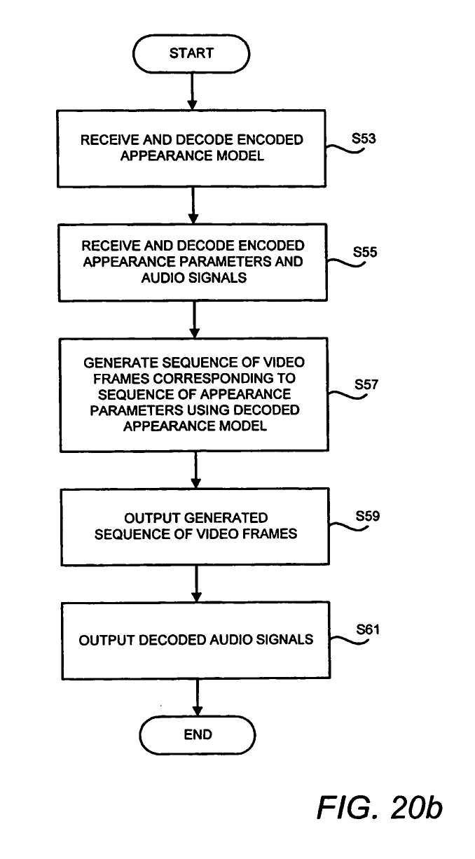

FIG. 20a is a flow chart illustrating the processing steps performed by a transmission side of the image transmission system shown in FIG. 19;

FIG. 20b is a flow chart illustrating the processing steps performed at a receiving side of the image transmission system shown in FIG. 19;

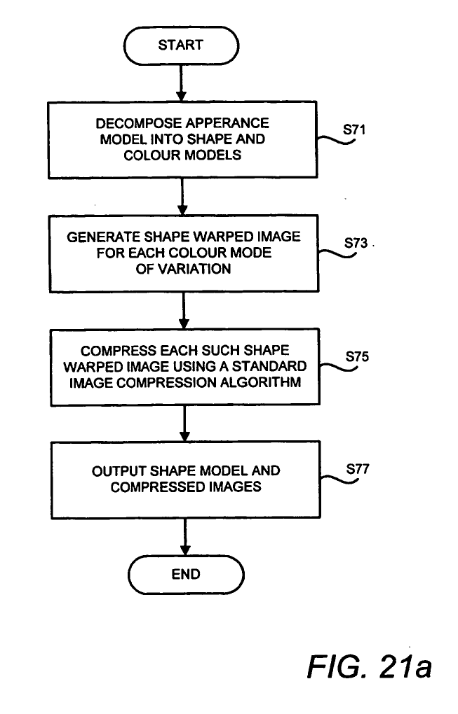

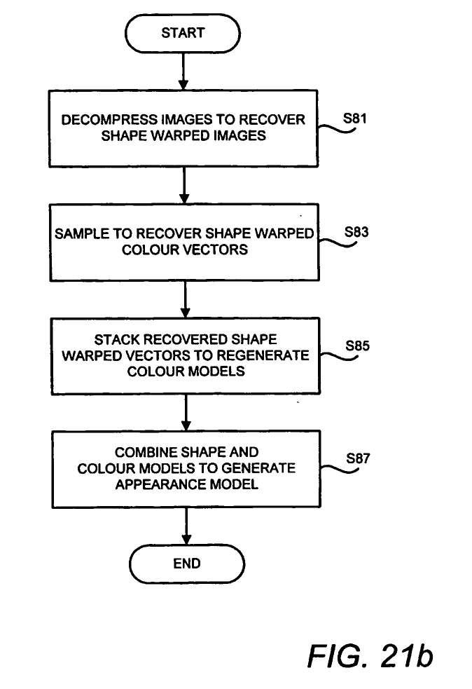

FIG. 21a illustrates the processing steps performed in encoding the image data;

FIG. 21b illustrates the processing steps performed in decoding the received image data when encoded using the processing steps shown in FIG. 21a.

FIG. 1 is an image processing apparatus according to an embodiment of the present invention. The apparatus comprises a computer 1 having a central processing unit (CPU) 3 connected to a memory 5 which is operable to store a program defining the sequence of operations of the CPU 3 and to store object and image data used in calculations by the CPU 3. Coupled to an input port of the CPU 3 there is an input device 7, which in this embodiment comprises a keyboard and a computer mouse. Instead of, or in addition to the computer mouse, another position sensitive input device (pointing device) such as a digitizer with associated stylus may be used.

A frame buffer 9 is also provided and is coupled to the CPU 3 and comprises a memory unit (not shown) arranged to store image data relating to at least one image, for example by providing one (or several) memory location(s) per pixel of the image. The values stored in the frame buffer for each pixel defines the colour or intensity of that pixel in the image. In this embodiment, the images are represented by 2D arrays of pixels, and are conveniently described in terms of Cartesian co-ordinates, so that the position of a given pixel can be described by a pair of x-y co-ordinates. This representation is convenient since the image is displayed on a raster scan display 11. Therefore, the x-coordinate maps to the distance along the line of the display and the y-coordinate maps to the number of the line. The frame buffer 9 has sufficient memory capacity to store at least one image. For example, for an image having a resolution of 1,000 by 1,000 pixels, the frame buffer 9 includes 10⁶ pixel locations, each addressable directly or indirectly in terms of a pixel coordinate x,y.

In the embodiment, a video tape recorder (VTR) 13 is also coupled to the frame buffer 9, for recording the image or sequence of images displayed on the display 11. Mass storage device 15, such as a hard disk drive, having a high data storage capacity is also provided and coupled to the memory 5. Also coupled to the memory 5 is a floppy disk drive 17 which is operable to accept removable data storage media, such as a floppy disk 19 and to transfer data stored thereon to the memory 5. The memory 5 is also coupled to a printer 21 so that generated images can be output in paper form, an image input device 23 such as a scanner or a video camera and a modem 25 so that the input images and output images can be received from and transmitted to remote computer terminals via a data network, such as the Internet. The CPU 3, memory 5, frame buffer 9, display unit 11 and mass storage device 13 may be commercially available as a complete system, for example as an IBM compatible personal computer (PC) or a workstation such as the Spark station available from Sun Microsystems.

A number of the embodiments of the invention can be supplied commercially in the form of programs stored on a floppy disk 19 or on other mediums, or as signals transmitted over a data link, such as the Internet, so that the receiving hardware becomes reconfigured into an apparatus embodying the present invention.

Overview

In this embodiment, the computer 1 is programmed to receive a source video sequence input by the image input device 23 and to generate a target video sequence from the source video sequence and pre-stored data generated during a training routine. In this embodiment, the source video sequence is a video clip of an actor acting out a scene, the target video sequence is a video clip of a second actor acting out the same scene and the training data are appearance models which model the appearance of the two actors.

FIG. 2 is a block diagram illustrating the functional modules implemented within the computer 1 and FIG. 3 is a flow chart illustrating the processing steps performed by these modules in generating the target video sequence from the source video sequence. As shown, the source video sequence 31 is input to a tracker unit 33 which processes each frame of the source video sequence in turn in order to track the movement of the first actor's head within the source video sequence. To perform this tracking, the tracker unit 33 uses a source appearance model 35 which models the variability of the shape and texture of the first actor's head. This source appearance model 35 is generated by a model builder 37 from a set of training images of the first actor which are stored in the image database 39. In tracking the first actor's head in the source video sequence 31, the tracker unit 33 generates, in step s1, for each frame, a set of appearance parameters which represents the appearance of the first actor's head in the frame. The appearance parameters for the current frame being processed are then input to an identity shift unit 41 which performs, in step s3, a transformation of the appearance parameters for the first actor, to generate corresponding appearance parameters for the second actor. The transformation used by the identity shift unit 41 is determined from the source appearance model 35 and a target appearance model 43 which models the variability of the shape and texture of the second actor's head. As with the source appearance model 35, the target appearance model 43 is generated in advance by the model builder 37 from a set of training images of the second actor which are stored in the training image database 39.

The modified appearance parameters generated by the identity shift unit 41 are then input to a player unit 45 which reconstructs, in step s5, corresponding image data for the modified appearance parameters and composites the image data back into the corresponding source video frame in order to generate a corresponding target video frame which is output, in step s7, for display. The processing performed in steps s1 to s7 is then repeated for the next source video frame until step s9 determines that there are no further source video frames to be processed.

A description will now be given of the appearance models that are used in this embodiment. This will be followed by a more detailed description of the operation of the tracker unit 33, the identity shift unit 41, the player unit 45 and the model builder 37.

Appearance Models

The appearance models 35 and 43 used in this embodiment are similar to those developed by Cootes et al and described in, for example, the paper entitled “Active Shape Models—Their Training and Application”, Computer Vision and Image Understanding, Vol. 61, No. 1, January, pages 38 to 59, 1995. These appearance models make use of the fact that some prior knowledge is available about the contents of head images. For example, it can be assumed that two frontal images of a human face will each include eyes, a nose and a mouth.

In order that the source appearance model 35 can model the variability of the first actor's face within the source video sequence, the training images should include images of the first actor having the greatest variation in facial expression and 3D pose. These training images may be generated from the source video sequence 31 itself or they may be generated in advance from previous images of the first actor. Similarly, in order that the target appearance model 43 can model the variability of the second actor's face, the training images used should include images of the second actor having the greatest variation in facial expression and 3D pose.

In this embodiment, all the training images are colour images having 500 by 500 pixels, with each pixel having a red, green and blue pixel value. The resulting appearance models 35 are a parameterisation of the appearance of the class of head images defined by the heads in the training images, so that a relatively small number of parameters (typically 15 to 40 for a single person) can describe the detail (pixel level) appearance of a head image from the class.

As explained in the applicants earlier International Application WO 00/17820 (the contents of which are incorporated herein by reference), the appearance model is generated by initially determining a shape model which models the variability of the head shapes within the training images and a texture model which models the variability of the texture or colour of the pixels in the training images, and by then combining the shape model and the texture model.

In order to create the shape model, the position of a number of landmark points are identified on a training image and then the position of the same landmark points are identified on the other training images. The result of this location of the landmark points is a table of landmark points for each training image, which identifies the (x, y) coordinates of each landmark point within the image. The modelling technique used in this embodiment then examines the statistics of these coordinates over the training set in order to determine how these locations vary within the training images. In order to be able to compare equivalent points from different images, the heads must be aligned with respect to a common set of axes. This is achieved by iteratively rotating, scaling and translating the set of coordinates for each head so that they all approximately fill the same reference frame. The resulting set of coordinates for each head form a shape vector (xⁱ) whose elements correspond to the coordinates of the landmark points within the reference frame. In this embodiment, the shape model is then generated by performing a principal component analysis (PCA) on the set of shape training vectors (xⁱ). This principal component analysis generates a shape model (Qₛ) which relates each shape vector (Xⁱ) to a corresponding vector of shape parameters (Pₛⁱ), by:

Pₛⁱ=Qₛ(xⁱ−\overline{x}) (1)

where xⁱ is a shape vector, \overline{x} is the mean shape vector from the shape training vectors and pⁱₛ is a vector of shape parameters for the shape vector xⁱ. The matrix Qₛ describes the main modes of variation of the shape and pose within the training heads; and the vector of shape parameters (pₛⁱ) for a given input head has a parameter associated with each mode of variation whose value relates the shape of the given input head to the corresponding mode of variation. For example, if the training images include images of the first actor looking left and right and looking straight ahead, then one mode of variation which will be described by the shape model (Qₛ) will have an associated parameter within the vector of shape parameters (pₛ) which affects, among other things, where the first actor is looking. In particular, this parameter might vary from −1 to +1, with parameter values near −1 being associated with the first actor looking to the left, with parameters values around 0 being associated with the first actor looking straight ahead and with parameter values near +1 being associated with the first actor looking to the right. Therefore, the more modes of variation which are required to explain the variation within the training data, the more shape parameters are required within the shape parameter vector pₛⁱ. In this embodiment, for the particular training images used, twenty different modes of variation of the shape and pose must be modelled in order to explain 98% of the variation which is observed within the training heads.

In addition to being able to determine a set of shape parameters pₛⁱ for a given shape vector xⁱ, equation (1) can be solved with respect to xⁱ to give:

xⁱ=\overline{x}+Qₛ^{T}pₛⁱ (2)

since QₛQₛ^{T} equals the identity matrix. Therefore, by modifying the set of shape parameters (pₛⁱ), within suitable limits, new head shapes can be generated which will be similar to those in the training set.

Once the shape model has been generated, similar models are generated to model the texture within the training heads, and in particular the red, green and blue levels within the training heads. To do this, in this embodiment, each training head is deformed into a reference shape. In the applicant's earlier International application, the reference shape was the mean shape. However, this results in a constant resolution of pixel sampling across all facets in the training faces. Therefore, a facet corresponding to part of the cheek, that has ten times the area of a facet on the lip, will have ten times as many pixels sampled. As a result, this cheek facet will contribute ten times as much to the texture models which is undesirable. Therefore, in this embodiment, the reference shape is deformed by making the facets around the eyes and mouth larger than in the mean shape so that the eye and mouth regions are sampled more densely than the other parts of the face. In this embodiment, this is achieved by warping each training image head until the position of the landmark points of each image coincide with the position of the corresponding landmark points depicting the shape and pose of the reference head (which are determined in advance). The colour values in these shape warped images are used as input vectors to the texture model. The reference shape used in this embodiment and the position of the landmark points on the reference shape are schematically shown in FIG. 4. As can be seen from FIG. 4, the size of the eyes and mouth in the reference shape have been exaggerated compared to the rest of the features in the face. As a result, when the shape warped training images are sampled, more pixel samples are taken around the eyes and mouth compared to the other features in the face. This results in texture models which are more responsive to variations in and around the mouth and eyes and hence are better for tracking the actor in the source video sequence. Various triangulation techniques can be used to deform each training head to the reference shape. One such technique is described in the applicant's earlier International application discussed above.

Once the training heads have been deformed to the reference shape, red, green and blue level vectors (rⁱ, gⁱ and bⁱ) are determined for each shape warped training head, by sampling the respective colour level at, for example, ten thousand evenly distributed points over the shape warped heads. A principal component analysis of the red level vectors generates a red level model (matrix Q^{r}) which relates each red level vector to a corresponding vector of red level parameters by:

pᵣⁱ=Qᵣ(rⁱ−\overline{r}) (3)

where rⁱ is the red level vector, \overline{r} is the mean red level vector from the red level training vectors and pⁱᵣ is a vector of red level parameters for the red level vector rⁱ. A similar principal component analysis of the green and blue level vectors yields similar models:

p_{g}ⁱ=Q_{g}(gⁱ−\overline{g}) (4)

p_{b}ⁱ=Q_{b}(bⁱ−\overline{b}) (5)

These colour models describe the main modes of variation of the colour within the shape-normalised training heads.

In the same way that equation (1) was solved with respect to xⁱ, equations (3) to (5) can be solved with respect to rⁱ, gⁱ and bⁱ to give:

rⁱ=\overline{r}+Qᵣ^{T}pᵣⁱ

gⁱ=\overline{g}+Q_{g}^{T}p_{g}ⁱ

bⁱ=\overline{b}+Q_{b}^{T}p_{b}ⁱ (6)

since QᵣQᵣ^{T}, Q_{g}Q_{g}^{T} and Q_{b}Q_{b}^{T} are identity matrices. Therefore, by modifying the set of colour parameters (pᵣ, p_{g} or p_{b}), within suitable limits, new shape warped colour heads can be generated which will be similar to those in the training set.

As mentioned above, the shape model and the colour models are used to generate an appearance model (Fₐ) which collectively models the way in which both the shape and the colour varies within the heads of the training images. A combined appearance model is generated because there are correlations between the shape and the colour variation, which can be used to reduce the number of parameters required to describe the total variation within the training heads. In this embodiment, this is achieved by performing a further principal component analysis on the shape and the red, green and blue parameters for the training images. In particular, the shape parameters are concatenated together with the red, green and blue parameters for each of the training images and then a principal component analysis is performed on the concatenated vectors to determine the appearance model (matrix Fₐ). However, in this embodiment, before concatenating the shape parameters and the texture parameters together, the shape parameters are weighted so that the texture parameters do not dominate the principal component analysis. This achieved by introducing a weighting matrix (Hₛ) into equation (2), such that:

xⁱ=\overline{x}+[Qₛ^{T} Hₛ⁻¹] [Hₛ pₛⁱ] (7)

where Hₛis a multiple (λ) of the appropriately sized identity matrix, i.e:

$${H}_{s} = ( \begin{matrix}λ & 0 & 0 & … & 0 \\ 0 & λ & 0 & … & 0 \\ 0 & 0 & λ & … & 0 \\ ⋮ & ⋮ & ⋮ & ⋰ & \\ 0 & 0 & 0 & & λ\end{matrix} ) \qquad ( 8 )$$

where λ as a constant. The inventors have found that values of λ between 1,000 and 10,000 provide good results. Therefore, Qₛ^{T} and pₛⁱ become:

\hat{Q}ₛ^{T}=Qₛ^{T} Hₛ⁻¹

\hat{p}ₛⁱ=Hₛ pₛⁱ (9)

Once the shape parameters have been weighted, a principal component analysis is performed on the concatenated vectors of the modified shape parameters and the red, green and blue parameters for each of the training images, to determine the appearance model, such that:

$${P}_{a}^{i} = {F}_{a} [ \begin{matrix}{\hat{p}}_{s}^{i} \\ {p}_{r}^{i} \\ {p}_{g}^{i} \\ {p}_{b}^{i}\end{matrix} ] = {F}_{a} {p}_{sc}^{i} \qquad ( 10 )$$

where pⁱₐ is a vector of appearance parameters controlling both shape and colour and pⁱ_{sc} is the vector of concatenated modified shape and colour parameters.

Once the modified shape model (\hat{Q}ₛ), the colour models (Qᵣ, Q_{g} and Q_{b}) and the appearance model (Fₐ) have been determined for both the source and the target images, these are stored as the source appearance model 35 and the target appearance model 43 respectively.

In addition to being able to represent an input head by a set of appearance parameters (pₐⁱ), it is also possible to use those appearance parameters to regenerate the input head. In particular, by combining equation (10) with equations (1) and (3) to (5) above, expressions for the shape vector and for the RGB level vectors can be determined as follows:

xⁱ=\overline{x}+Vₛpₐⁱ (11)

rⁱ=\overline{r}+Vᵣpₐⁱ (12)

gⁱ=\overline{g}+V_{g}pₐⁱ (13)

bⁱ=\overline{b}+V_{b}pₐⁱ (14)

where Vₛ is obtained from Fₐ and \hat{Q}ₛ, Vᵣ is obtained from Fₐ and Qᵣ, v_{g} is obtained from Fₐ and Q_{g}, and V_{b} is obtained from Fₐ and Q_{b}. In order to regenerate the head, the shape warped colour image generated from the colour parameters must be warped from the reference shape to take into account the shape of the head as described by the shape vector xⁱ. The way in which the warping of a shape free grey level image is performed was described in the applicants earlier International application discussed above. As those skilled in the art will appreciate, a similar processing technique is used to warp each of the shape warped colour components, which are then combined to regenerate the head image. As will be described below, the player unit 45 uses this technique to regenerate the head image of the second actor from the identity shifted appearance parameters output by the identity shift unit 41.

Tracker Unit

The function of the tracker unit 33 is to track the first actor's head within the source video sequence 31 and to generate, for each source video frame, a set of pose parameters and appearance parameters representative of the first actor's head in that frame. FIG. 5 is a flow chart illustrating the processing steps performed by the tracker unit 33 in processing each source video frame. As shown, in step s11, an initial estimate of the pose and appearance parameters for the head in the current frame being processed is determined using a simple and rapid technique. For all but the first frame of the source video sequence 31, this is achieved by simply using the pose and appearance parameters determined for the preceding source video frame. In this embodiment, the appearance parameters effectively define the shape and texture of the first actor's head within the frame, and the pose parameters define the scale, position and orientation of the head within the frame. In this embodiment, for the first source video frame, the initial estimate of the appearance parameters is set to the mean set of appearance parameters and the pose parameters are initially estimated by the user manually placing the mean head over the head in the image.

The processing then proceeds to steps s13, s15 and s17, where an iterative technique is used in order to make fine adjustments to the initial estimate of the appearance parameters. The adjustments are made in an attempt to minimise the difference between the head described by the pose and appearance parameters (the model head) and the head in the current video frame (the image head). With approximately 20 appearance parameters, this represents a difficult optimisation problem. This can be performed by using an optimisation technique to reduce iteratively the mean squared error between the image pixels of the image head and those predicted by a particular choice of pose and appearance parameter values. In particular, minimising the following error function E(zₐ):

E(zₐ)=[I−f(zₐ)]^{T}[I−f(zₐ)] (15)

where I is a vector of actual image pixels at the locations where the appearance model predicts a value (the appearance model does not predict all pixel values since it ignores background pixels and usually only predicts a sub-sample of pixel values within the head being modelled); and f(zₐ) is the vector of image pixels generated from the appearance model and the current values of the combined pose and appearance parameters (zₐ). As those skilled in the art will appreciate, E(zₐ) will only be zero when the model head (i.e. f(zₐ)) predicts the actual image head (I) exactly. This would never be expected to be achieved in any real example. However, as the error tends towards zero so the reconstruction will more closely resemble the image. Standard steepest descent optimisation techniques could be used to minimise this function. However, this requires calculating the differential of the appearance model which is slow and not suited to “real time” applications. In addition such algorithms are plagued by the problem of local minima (configurations where no small deviation of the appearance parameters decreases the error, but larger steps do). Experience shows that the error surface for this application to be full of such local minima. In the paper entitled “Interpreting Face Images using Active Appearance Models”, published in the Third International Conference on Automatic Face and Gesture Recognition, 1998, pages 300-305, Japan, Edwards et al make the approximation that on average over the whole parameter space, the differential of the appearance model is constant. This therefore simplifies the optimisation process so that the change in the appearance parameters at each iteration is calculated from:

Δzₐ=A[I−f(zₐ)] (16)

where A is the so-called “active matrix”, which is determined beforehand during a training routine after the source appearance model 35 has been determined. As mentioned above, this parameter update is iteratively determined until some convergence criteria has been met or until a predetermined number of iterations have been performed or until a predetermined amount of time has elapsed. The processing then proceeds to step s19 which outputs the determined pose and appearance parameters for the current source video frame.

Identity Shift Unit

As discussed above, the function of the identity shift unit 41 is to receive the appearance parameters representative of the first actor's head in the current source video frame being processed and to modify those appearance parameters so that they relate to the second actor's head. The way in which this relationship is determined in this embodiment will now be described. Firstly, a relationship is determined that relates source shape parameters to target shape parameters. This is achieved by finding the shape parameters for the second actor which minimises the difference between the deviation from the mean of corresponding shape vectors. In this embodiment, this is done by determining the values of the target shape parameters (p^{trgt}ₛ) which minimises the following function:

|(Qₛ^{trgt}Pₛ^{trgt}+\overline{x}^{trgt}−xₒ^{trgt})−S Qₛ^{srce}pₛ^{srce}|² (17)

where Xₒ^{trgt} is chosen manually as the target shape that corresponds with X^{srce} (often Xₒ^{trgt}=\overline{X}^{trgt}); and S is a matrix that maps source shapes to target shapes by re-ordering the landmark points. The matrix S is determined in advance and may just be the identity matrix if the same landmark points are used for the target and source shape models. This function can be evaluated to generate the following equation for the vector of target shape parameters (p^{trgt}ₛ):

pₛ^{trgt}=(Qₛ^{trgt})^{-p} (S Qₛ^{srce}pₛ^{srce}+x^{trgt}−\overline{x}^{trgt}) (18)

where (Qₛ^{trgt})^{-p} is the standard pseudo inverse of Qₛ^{trgt} given by:

(Qₛ^{trgt})^{-p}=((Qₛ^{trgt})^{T}Qₛ^{trgt})⁻¹ (Qₛ^{trgt})^{T} (19)

Therefore, for a given source appearance model and target appearance model, equation (18) can be generalised to:

pₛ^{trgt}=Rₛ·pₛ^{srce}+rₛ

where, in this case,

Rₛ=(Qₛ^{trgt})^{-p} S Qₛ^{srce} and rₛ=(Qₛ^{trgt})^{-p} (xₒ^{trgt}−\overline{x}^{trgt}) (20)

where Rₛ is a fixed matrix and rₛ is a fixed vector of offsets which can be determined automatically in advance using equation (20). However, equation (20) defines a mapping between source shape parameters and target shape parameters—what is desired is an equation that maps source appearance parameters to target appearance parameters. This equation can be determined by separating the shape and colour parts of equation (10) (which relates both the concatenated shape and colour parameters to appearance parameters) and inserting the appropriate expressions for the source and target shape parameters into equation (20). In particular, rearranging equation (10) in terms of the appearance parameters and the shape parameters gives:

$$[ \begin{matrix}{p}_{s} \\ {p}_{r} \\ {p}_{g} \\ {p}_{b}\end{matrix} ] = {( {F}_{a} )}^{T} {p}_{a} = [ \begin{matrix}{F}_{as}^{T} \\ {F}_{ac}^{T}\end{matrix} ] {p}_{a} \qquad ( 21 )$$

since Fₐ^{T}Fₐ is the identity matrix. Therefore, the shape parameters are related to the corresponding appearance parameters by:

pₛ=Fₐₛ^{T}pₐ (22)

Therefore, inserting the appropriate equations for the source and target shape parameters into equation (20) gives:

(Fₐₛ^{trgt})^{T} pₐ^{trgt}=Rₛ·(Fₐₛ^{srce})^{T}·pₐ^{srce}+rₛ (23)

Therefore, pₐ^{trgt} is related to pₐ^{srce} by:

pₐ^{trgt}=((Fₐₛ^{trgt})^{T})^{-p}·Rₛ·(Fₐₛ^{srce})^{T}·pₐ^{srce}+((Fₐₛ^{trgt})^{T})^{-p}·rₛ

or

pₐ^{trgt}=Rₐ·pₐ^{srce}+rₐ (24)

In other words, in this embodiment, the target appearance parameters are calculated as a predetermined linear weighted combination of the source appearance parameters plus some predetermined offset vector.

Therefore, as those skilled in the art will appreciate, the desired transformation between source and target appearance parameters can be set up automatically, once the source and target appearance models have been determined and once the matrix S and the vector Xₒ^{trgt} have been defined.

Although the relationship between the target appearance parameters and the source appearance parameters has been determined only using that part of the appearance models which relate to the shape (i.e. using only Fₐₛ), the texture will still change in the target sequence because the shape and texture are constrained by the model not to change independently. Therefore, a change in the shape will induce a corresponding and consistent change in the texture.

Finally, once the “identity shifted” appearance parameters have been determined, the pose parameters are mapped directly from the source to the target, allowing the user to scale the size and translation independently and to add an offset to the rotation.

Player Unit

As mentioned above, the function of the player unit 45 is to convert the identity shifted shape and colour parameters back into image data and to recombine this image data with the source video frame to generate a corresponding target video frame. FIG. 6 is a flow chart illustrating the processing steps performed by the player unit 45 in regenerating the corresponding target video frames.

As shown in FIG. 6, initially the player unit 45 receives, in step s31, the modified pose and appearance parameters output by the identity shift unit 41 for the current target video frame to be generated. Then in step s33, these modified appearance parameters are converted back into image data using equations (11) to (14) and the technique described above. This regenerated image data is then composited, in step s35, into the current source video frame being processed or alternatively onto a single colour image, such as blue, to produce a “blue screen” sequence to be used for subsequent compositing. In this way, the appearance of the first actor in the current source video frame being processed is changed so that it looks like the second actor. The processing of steps s31 to s35 are then repeated for the next source video frame until step s37 determines that there are no further source video frames to be processed.

FIG. 7 shows some example video frames which illustrate the results of this image processing system. In particular, FIG. 7a shows three frames of a source video sequence, FIG. 7b shows an image corresponding to the target appearance model which is used and FIG. 7c shows the corresponding three frames of the target video sequence obtained in the manner described above. As can be seen by comparing the corresponding source and target image frames, the facial expressions of the first actor in the source video sequence are superimposed on the second actor's face (in this case a computer generated figure). As those skilled in the art will appreciate, this is a powerful tool since it allows the generation of an animated film sequence from a film sequence of a real actor. It is therefore not necessary to manually generate each frame of the computer animation, since these are automatically generated through the image processing system described above.

Model Builder User Interface

A user interface provided by the model builder will now be described with reference to FIGS. 8 to 15.

The user interface is operable in two different modes, a track mode and a markup mode. FIG. 8 shows a display screen 200 that the model builder 37 causes the display 11 to display to the user when the markup mode is selected. The display screen has a conventional Windows style format with a title bar 200a identifying the particular application, a number of drop down menus 201 and an icon bar 201a enabling selection of a number of conventional options such as cut, copy, paste, print and help. Beneath these are provided mode buttons 202 and 203 one labelled track and the other labelled markup to identify the two different modes. The markup button 203 is shown in relief to indicate that the markup mode is currently selected.

The display screen 200 also contains a number of windows that are empty when the user interface is initially activated. Although not shown in FIG. 11, when the display 200 is initially activated, the user clicks on the drop down menu file in known manner and selects the command “open” movie. Upon selection of this command the user is presented with a list of available video or frame sequences stored by the image processing apparatus. The user then selects the required movie in known manner, for example by double clicking on the displayed file name. Once a movie has been selected, then the model builder 37 causes an image 207 to be displayed in a main window 204 and a reference image 208 to be displayed in subsidiary window 205 as shown at step S100 in FIG. 9. The reference image 208 is overlain by a landmark point mesh m in which each landmark point P has previously been positioned at the corresponding correct location on the image. The image 207 is similarly overlain by a landmark mesh m′. However, in this case, the landmark points P have not yet been moved to match the actual image shown. Thus, the landmark mesh m′ overlying the image 207 may be that previously determined for the reference image (or another image of the sequence) and at least some of the landmark points will be in the wrong position because the image has changed (for example as shown, the persons mouth has opened and the eyebrows have moved). In this embodiment, the model builder 37 also causes a list 204 of the file names of the images forming the video sequence to be displayed in an image list window 209 so as to facilitate subsequent selection of images by the user. Where none of the images of the image sequence have been marked up by the user, then the main window 207 will display the first image of the sequence with the landmark points mesh m having an initial configuration determined by the average or mean image of the sequence. In this case, the window 208 may be blank or may display a reconstruction of the mean image overlain by the landmark point mesh for that mean image.

For the purposes of the following description, it will be assumed that at least one image of the sequence has already been marked up and that, as illustrated diagrammatically in FIG. 8, the subsidiary window 208 shows a previous image in the image sequence for which the landmark point mesh m has already been adjusted by a user in the manner to be described below. As can been seen from FIG. 8, each of the landmark points Px is identified as a black dot.

In order to adjust the position of a landmark point Px, the user moves the computer mouse or other pointing device of the computer in known manner to position a cursor 207 (shown as an arrow in FIG. 8) over the landmark point whose position is to be adjusted. As shown in FIG. 8, the cursor 207 is positioned over the landmark point P1.

When, at step S101 in FIG. 9, the model builder detects that the cursor 207 has been positioned over a particular landmark point, the model builder 37 highlights that landmark point. The selected landmark point may be highlighted by, for example, causing the landmark point to flash or changing the colour of the landmark point. Then, at step S102 in FIG. 9, the model builder 37 highlights the corresponding landmark point P′1 in the subsidiary window 208. The corresponding landmark point P′1 may be highlighted in the same manner as the selected landmark point P1. In this embodiment, the model builder also causes a text description of the selected landmark point to be displayed in a landmark point description window 206.

Highlighting of the corresponding landmark point P′1 on the previously marked image shown in the subsidiary window 208 enables the user to determine more easily where the selected landmark P1 should be positioned on the unmarked up image 207. The displayed text description of the landmark point also assists the user in correctly repositioning the landmark point P1. In this case, the already marked image 208 shows that the landmark P′1 is at the centre of the hairline and this is confirmed by the description of the selected landmark point as “hairline, centre” in the window 206.

In order to move the selected landmark point P1, the user clicks the cursor on the selected landmark point and then drags the selected landmark point and drops it on the required new position. When, at step 103 the model builder 37 determines that the user has dragged and dropped the selected landmark point to a new position, then at step S104, the model builder stores the modified landmark point mesh and then checks at step S105 whether another landmark point has been selected. If the answer at step S105 is yes, then steps S101 to S104 are repeated. If, however, the answer is no, then the model builder determines at step S106 whether the markup procedure has been ended by the user either selecting exit from the drop down file menu or selecting the track mode by clicking on the track button 202. If the answer at step S106 is no, then the model builder returns to step S100 awaiting selection of another image.

The procedure described above with reference to FIGS. 8 and 9 may be carried out for each image in the image sequence selected by the user. As can be seen from FIG. 10 which shows the markup drop down menu 201′ dropped down, a user can select to add one or more images to the image sequence by clicking on the command “Add Image”, in response to which the model builder 37 will present the user with a list of stored image file names from which the user can select a further image to be marked up.

As described above, the guide or previously marked up reference image 208 shown in the subsidiary window 205 is a default image selected by the model builder. The user may, however, opt to replace the existing reference or guide image by the image 207 shown in the main window 204 after he has adjusted the position of the landmark point Px to his satisfaction by selecting the command “Set As Guide Image” in the dropped down markup menu 201′.

The drop down markup menu 201′ also provides the facility for the user to set the properties of each of the landmark points of the landmark point mesh m of the current image. Thus, when the user selects the option “Mark All as Set” in the markup drop down menu, the model builder 37 causes all of the landmark points Px of the current image 207 to be set or locked into their current position, thus preventing accidental displacement. The user may reverse the setting of the positions of the landmark points Px by selecting “Mark All as Set” from the markup drop down menu in which case the model builder 37 will change the properties of the landmark points so that their positions can again be adjusted. The mark up drop down menu 201′ also provides the user with the option of, after having set the position of all of the landmark points Px, unsetting or unlocking the position of one of the landmark points by selecting the landmark point whose position he wishes to change and then selecting the command “Mark As Unset” in the markup drop down menu. The markup drop down menu also provides a “Point Properties” command that enables a user to change the name of a landmark point and also to change the description displayed in the landmark point description window 206. This enables the user to, for example, associate with a landmark point a description that is specific to the particular image sequence being processed.

The markup drop down menu 201′ also provides provision for the user to select an “Autofit” function. When this is selected, the model builder 37 uses a correlation procedure to determine, for each landmark point Px, the pixel, to within plus or minus one pixel, in the current image that most closely corresponds in colour to the pixel at which that landmark point is located in a previously marked up image and then adjusts the position of that landmark point accordingly. In this embodiment, this correlation procedure is effected by first dividing the search area into quadrants and searching for correspondence in colour with a relatively coarse or low resolution sampling, then subdividing the most closely matching quadrant again and repeating the searching process using a higher resolution sampling then subdividing and repeating again until the search area is a nine pixel area. This sampling tree approach facilitates rapid convergence to the pixel that provides the lowest error score. The matching criterion between pixels may be adjusted to account for changes in background illumination level by, for example, comparing corresponding background pixels in the previously marked up and current image.

The markup procedure described so far is concerned with obtaining data for deriving the shape model. The markup screen may also be used to enable a user to adjust the position of the landmark points of the reference shape used, as described above, to generate the texture model. In order to do this, the user selects the command “Reference Shape” from the markup drop down menu and, in response, the model builder 37 displays in the window 204 the reference shape which may, as described above, be the mean shape for the particular image sequence or may be a warped reference shape as shown in FIG. 4. The landmark point adjustment procedure can then be carried out as described above.

The track mode of operation of the model builder interface will now be described with reference to FIGS. 11 to 15.

FIG. 11 shows an example of the display screen 210 that the model builder 37 causes the display 11 to display when a user selects the track mode by clicking on the track button 202. As can be seen from a comparison of FIGS. 8 and 11, the drop down menus 201 in FIG. 11 differ from those shown in FIG. 8 in that a frame drop down menu replaces the markup drop menu shown in FIG. 8.

When the user first selects the track mode, then the display screen shows empty windows 211 and 212 for displaying a marked up original image and the corresponding reconstructed image, respectively. Above these is provided error profile display window 215 having above it a frame number display window 226, an error value display window 227 and forward, go to end of image sequence, reverse and go to beginning of image sequence control buttons 218 to 221 for enabling a user to move back and forth through a movie or image sequence.

Although not shown, file consisting of an image sequence to be processed is selected by the user clicking on the file drop down menu and selecting the option “Open Movie”. In response to this, the model builder 37 will provide the user with a list of file names for the available movie sequences from which the user will select the desired sequence. When the desired sequence has been selected, then the movie builder causes the display 11 to show in the window 211 the frames or images 213 of the original image sequence one after another with, in each case, the image being open overlain by the corresponding landmark point mesh m. At the same time, the model builder 37 causes the display 11 to display in the window 212 the reconstructed image or frame corresponding to the original image or frame shown in the window 211 (step S110 in FIG. 12).

As each original frame is displayed in the window 211, the model builder 37 causes the corresponding frame number to be displayed in the frame window number 226, determines the error value for the reconstructed image as described above, displays a corresponding error value in the error value window 227 and also indicate the error value for that frame graphically in the error profile window 215 so that, as successive frames of the original image sequence are displayed, a running error profile 216 is generated with each point on the profile representing the error for the corresponding frame. The original frame for which the error is currently being processed is indicated by an error bar cursor 217. In the example shown, the current frame is frame 0140 and the error is 40 (where the error may vary from 0 to 100, for example).

The images of the original sequence are processed in time sequential order and resulting error profile stored (step S112 in FIG. 12). A user may choose to move forward through the images of the sequence by selecting the button 218 or to move to the end of the image sequence by selecting the button 219. A user may also choose to run the images in reverse by selecting the button 220 or choose to go to the beginning of the image sequence by selecting the button 221.

In addition, a user may use the pointing device to drag and drop the error cursor bar 217 to any frame position along the error profile so that, as shown in FIG. 11, a user can interrupt the tracking procedure at a particular frame F1 and restart it at a later frame F2 so leaving a gap 216a in the error profile. A user may drag and drop the error bar cursor 217 onto any frame position along the error profile.

When the model builder determines 37 at step S120 in FIG. 13 that the error bar 217 has been positioned over a particular frame position on the error profile, then at step S121, the model builder displays that frame in the window 211 overlain with its landmark point mesh m and displays in the window 212 the corresponding reconstructed image. In this embodiment, the model builder also displays the frame number in the frame window 226 and the error value in the error window 227. A user may select a particular frame of the image sequence on the basis of the error profile, for example the user may select a frame where the error is particularly large, for example the frame F3 having the error E3 in FIG. 11 and the model builder 37 will then cause the original image and the corresponding reconstructed image to be displayed. The display of the original image 213 with its overlying landmark point mesh m enables the user to determine whether any of the landmark points P should be manually adjusted. If so, then as shown in FIG. 14, the user selects the frame drop down menu and clicks on “Add to Database” causing the model builder 37 to add the image 213 to the database. The user can then return to the markup mode and manually adjust the landmark points for that image in the manner described above.

Displaying the reconstructed image 214 in addition to the original image may enable the user to determine visually where the reconstructed image deviates from the original image and to concentrate on the landmark points in that region.

As can be seen from FIG. 14, the drop down frame menu also provides an option to “Find Worst Tracked” image. When this option is selected, then at step S130 in FIG. 15, the model builder 37 determines the reconstructed image presenting the largest error and at step S131 displays that reconstructed image in the window 212, displays the corresponding original image in the window 211, moves the cursor 217 to the correct frame location of the error profile and displays the corresponding frame number and error value in the frame and error windows 226 and 227, respectively. The user may then visually check the landmark point mesh m on the original image 213 and compare the original image and the reconstructed image to determine whether any manual adjustment of the landmark points is desirable. If so, then the user may click on “Add to Database” as described above. When the model builder 37 determines this option has been selected at step S132 in FIG. 15, the model builder adds the image to the database at step S133. The user may then return to the markup mode and select that particular added image to enable manual adjustment of one or more landmark points on that image.

Once the landmark point mesh for that particular image has been corrected, then the user may return to the track mode and repeat the process until he is satisfied that the worst error is within acceptable bounds. This procedure means that it is not necessary for the user to himself select the frames to be examined from the error profile, rather the model builder 37 selects the frame automatically by determining the frame for which the error value is worst.

The track mode thus enables a user to determine whether the landmark point mesh m for additional ones of the images forming the image sequence should be manually adjusted so as to improve the accuracy of the reconstructed image sequence.

It will be appreciated that, in the markup mode of the model builder interface, the image title list and corresponding window may be omitted and that, although desirable, the landmark point description window 206 may also be omitted. In the track mode, also be omitted. In the track mode, a facility may be provided to enable a user to zoom in on a particular part of the error profile 216 so that the individual error bars can be distinguished. Also the frame number and the frame number and error value windows may be omitted. In addition, although display of the reconstructed image in the window 212 may assist the skilled operator in determining where the error in the reconstructed image lies, this may also be omitted if desired because the user should be able to determine from the original image whether any of the landmark points P are incorrectly placed.

Modifications and Alternative Embodiments

In the first embodiment, the target appearance model was representative of a computer generated head. This is not essential. For example, the target appearance model may be for a hand-drawn head or for another real person. FIGS. 7d and 7e illustrate how an embodiment with a hand-drawn character might be used in character animation. In particular, FIG. 7d shows a hand-drawn sketch of a character which may be combined in the manner described above to generate the target frames shown in FIG. 7e. As can be seen from a comparison of the corresponding frames in the source and target video sequences, the hand-drawn sketch has been animated automatically using this technique.

A system has been described above which receives a source video sequence and processes it to change the appearance of an actor to that of another actor. This gives the impression that the video sequence has been generated by the second actor. This can be used in various cinematic and animation scenarios. For example, the source video sequence might be a video sequence of an unknown actor acting out a scene and the target model may be for a famous person. The resulting target video sequence would then show the famous person acting out the scene.

As an alternative to completely changing the identity of the person in the source video sequence, the system could be used to improve the appearance of the person in the source video sequence. For example, the source and the target models may be for the same person, with the source appearance model modelling the normal look of the person and with the target appearance model modelling the person when they look their “best”. In this way, the system can be used to improve the appearance of the person within the source video sequence. Such a system could be used, for example, in a video phone application where the user might not want to use the phone if they are not looking their best (because, for example, they have just got out of bed).

During the training stage for such a system, the “general” appearance model would be generated from various images of the user both looking his best and not looking his best and the “ideal” appearance model would be generated only using training images of the user when he is looking his best. The appropriate identity shifting transformation can then be determined in the manner described above.

Alternatively still or in addition, the target appearance model may be used to generate a higher resolution version of source images from a low resolution camera. In this case, each low resolution frame would be processed using a low resolution appearance model to generate the corresponding low resolution appearance parameters which would then be applied to the “identity shift unit”, which would perform any identity shifting (if appropriate) and generate the corresponding high resolution appearance parameters. These would then be converted using the appropriate high resolution target appearance model to generate the corresponding high resolution image. Such an embodiment would be particularly useful in video phones and video conferencing systems since the camera used in these systems often gives very low quality images.

During the training stage for such a system, the low resolution appearance model would be generated from low resolution training images and the high resolution appearance model would be generated from high resolution images. Since the appearance models are generated from images having different resolutions, it is likely that there will not be a one to one correspondence between the number and value of the low resolution appearance parameters and the high resolution parameters. Therefore, in nearly all cases, a mapping function will be required to map between the low resolution appearance parameters and the high resolution appearance parameters. The required mapping can be determined during the training phase by analysing the relationship between the low and high resolution appearance parameters generated for images of the same subject but at different resolutions. In this embodiment, this mapping is performed by the identity shift unit and combined with any desired identity shift transformation.

In the above embodiments, a source appearance model and a target appearance model were used to modify a source video sequence 31 showing a first actor acting out a scene to generate a target video sequence 47 showing a second actor acting out the scene. This identity-shifting technique used two separate appearance models. A simplified embodiment will now be described in which the target video sequence 47 is generated from the source appearance model 35 and a single image of the second actor.

FIG. 16 is a block diagram of an image processing system according to this embodiment. As shown, the processing system is similar to the processing system shown in FIG. 2 except it does not use the identity-shift unit 41. Instead, the appearance parameters generated by the tracker unit 33 are used to directly drive the target appearance model 43 in the player unit 45. The way in which the target appearance model 43 is generated in this embodiment will now be described with reference to FIG. 17.

Initially, in step s151, the model builder 37 retrieves the source appearance model 35. The processing then proceeds to step s153 where the target image of the second actor is marked-up using the “mark-up model” of operation of the model-builder which is described above with reference to FIGS. 8 and 9. The processing then proceeds to step s155 where the target image is modified so that the expression on the second actor's face matches the mean expression of the first actor's face that is associated with the source appearance model 35. As those skilled in the art will appreciate, if the expression of the second actor in the target image already matches that of the mean expression of the source appearance model 35, then step s155 can be omitted. The way in which this step is performed in this embodiment will now be described in more detail.

Once the initial target image has been marked-up with the mesh of landmark points, the system knows the x-y pixel coordinates of each of the landmark points on the mesh of landmark points shown in FIG. 8. The system then uses part of the source appearance model to determine deviations of shape to be applied to the shape of the second actor in the target image. In particular, the system tweaks shape parameters (pₛ) and applies them to Qₛ^{T}pₛ to determine deviations from the mean shape of the source appearance model and uses these deviations to directly change the position of the landmark points in the mesh in order to change the expression of the second actor in the target image. The target image is then warped so that the original x-y positions in the target image correspond to the new x-y positions defined by the new mesh. This process is then repeated until the expression on the second actor's face in the modified target image corresponds to the mean expression of the first actor's face associated with the source appearance model.

As those skilled in the art will appreciate, in some instances, this process may result in there being no pixel data for some of the modified target image pixels. For example, if the second actor has his mouth closed in the original target image and in the mean expression the first actor has his mouth open, then there will be no texture information corresponding to the teeth of the second actor. In this case, texture data from the first actor can be directly used in the modified target image.

After step s155 has been performed, the processing then proceeds to step s157 where the modified target image is scaled and reposed in order that it matches that of the source appearance model, and then the shape vector for the modified target image is used to replace the mean shape vector (\overline{x}) of the source appearance model. The processing then proceeds to step s159 where the modified target image is warped to the shape-free texture frame discussed above and red, green and blue level vectors are extracted and these are used to replace the mean red, green and blue level vectors (\overline{r}, \overline{g} and \overline{b}) of the texture models. The resulting modified source appearance model is then stored, in step s161, as the target appearance model 43. The processing then ends.

As those skilled in the art will appreciate, what is effectively happening in this embodiment is that the deviations of shape and texture that are generated from the source video frames using the source appearance model are being applied directly to the shape and texture of the target image to generate the target animated sequence.

As those skilled in the art will appreciate, instead of driving the target appearance model 43 directly from the source appearance parameters, the identity-shifting technique discussed above in the first embodiment may be used, however, since the target appearance model 43 is directly derived from the source appearance model 35, the modes of variation of the two models already have a one-to-one correspondence and therefore, the identity-shifting techniques used in the first embodiment are unlikely to improve the results significantly.

In the embodiment that has just been described, the target image was deformed to the mean expression of the source model by the operator tweaking the shape parameter values via the model-builder user interface. As an alternative, the initial target image may be modified directly using an image editor. In this case, steps s153 and s155 would be reversed in order, so that only the modified target image would be marked up using the mesh of landmark points.

The inventors have identified that the above technique works well if the lighting of the person in the source video is similar to the lighting of the person in the target image since changes in the texture that occur when the face moves are largely due to the effects of lighting. However, when the lighting is very different in the target image, the resulting texture variation can result in unwanted artefacts in the target video sequence 47. Therefore, in such cases it is useful to modify the target image to make the illumination of the second actor look similar to that of the first actor used to generate the source appearance model 35. The preferred way in which this is done will now be described with reference to FIG. 18.

In particular, FIG. 18 is a flowchart illustrating the processing steps performed in order to modify the target image so that the lighting conditions for the second actor in the target image corresponds to the lighting associated with the source appearance model 35. As shown, in step s171, a lighting model together with its pseudo-inverse are retrieved (if they are available) or they are created if they are not. Lighting models have recently been proposed by Debevec et al in their paper entitled “Acquiring the reflectance field of a human face”, SIGGRAPH 2000. These lighting models are associated with a particular user and have been used to generate images of that user under different lighting conditions.

One way of generating the lighting model is to take pictures of the user from a single viewpoint under various different lighting conditions. In particular, the user is positioned within a room in which an array of light sources are distributed around the user so that light can be emitted towards the user from various different directions. This might be done, for example, using an array of 100 light sources arranged around the user in a sphere. The lighting model is then generated by illuminating the user with each of the 100 lights separately and by taking a picture of the user when illuminated by each of the lights. The 100 images thus derived are then used to generate the lighting model by stacking the images into a matrix (Mᵤ), with each column in the matrix being obtained from one of the images. With 100 light sources, this generates a N×100 matrix lighting model (Mᵤ), where N is the number of pixels used from the images. In this embodiment, not all of the pixels from the images are used in the lighting map. In particular, pixels corresponding to the background are not used nor are pixels that correspond to the user's hair or eyes. The pixels in the image that are used are then formed into a vector of pixel intensities (or RGB values if colour images are being used) and the vectors for all of the images generated under all of the different lighting conditions are then stacked up column by column to generate the lighting model (Mᵤ) for that user. It has been shown that this lighting model can then be used to generate an image of the user under any lighting conditions as being a weighted linear combination of the images in the lighting model, i.e.:

Iᵤ^{Li}=Mᵤ·Lᵢ (25)

where Iᵤ^{Li} is the image pixels for the user in the lighting conditions defined by the lighting vector Li.

The inventors have realised that by taking the pseudo-inverse of the lighting model (i.e. Mᵤ^{-p}) using the corresponding formula of equation (19) given above, the lighting conditions of a corresponding image vector can be determined from:

Lᵢ=Mᵤ^{-p}·I^{Li} (26)

and that this can be used to modify the lighting conditions of the target image. The way in which this is done will now be described in more detail.

After the lighting model (which can be for any user—it does not have to be for one of the first or second actors) and its pseudo-inverse have been received, the processing proceeds to step s173 where the source appearance model 35 is retrieved together with the target image of the second actor. The processing then proceeds to step s175 where the lighting for the source appearance model and for the target image are determined as follows:

Lₜ=Mᵤ^{-p}·Iₜ

Lₛ=Mᵤ^{-p}·\overline{I}ₛ (27)

Where Iₜ is the vector of image pixels obtained from the target image and \overline{I}ₛ is the corresponding vector of image pixels taken from the mean texture of the source model. It does not matter that the subject in the target image and the mean source image are different, provided the scale and pose of the first and second actor's faces represented in these images is the same as that of the user's face used to generate the lighting map and that corresponding pixel values are taken from these images to form the image vectors used in the above equations. In other words, there should be correspondence between the pixel values used to generate the lighting map and the pixel values in the target image and the mean source image so that differences between the image vectors only relate to differences in lighting and differences in appearance between the different people.

The processing then proceeds to step s177 where an image of the user (associated with the lighting model) under the lighting conditions of the target image is determined in accordance with the following formula:

Iᵤ^{Lt}=Mᵤ·Lₜ (28)

The processing then proceeds to step s179 where a ratio image (R) is determined by dividing the individual pixel values of the target image (Iₜ) by the corresponding pixel values of the user image (Iᵤ^{Lt}) generated in step s177. The processing then proceeds to step s181 where a target image under the lighting conditions of the source appearance model is generated by determining an image of the user (associated with the lighting model) under the lighting conditions of the source appearance model and then weighting the individual elements of that image vector with the corresponding components of the ratio image determined above. In other words, by determining the following:

Iₜ^{Ls}=R{Mᵤ·Lₛ}=R{Iᵤ^{Ls}} (29)

Please note that in this equation it is not the vector of the ratio image (R) which is multiplied with the image vector Iᵤ^{Ls}, it is the individual pixel values of R that are multiplied with the corresponding pixel values of Iᵤ^{Ls}. In other words, the first pixel value of R is multiplied with the first pixel value of Iᵤ^{Ls}, the second pixel value of R is multiplied with the second pixel value of Iᵤ^{Ls} etc. The resulting modified target pixels can then be re-composited back into the target image with the other pixels of the eyes and hair and then this modified target image can be used in the manner described above with reference to FIGS. 16 and 17 to generate the target appearance model 43.

In the above embodiment, the user of the lighting model was different to the second actor in the target image. Whilst the technique works reasonably in this situation, the quality of the re-lighting can be improved if the user associated with the lighting model has a similar appearance to the second actor in the target image (and preferably also to the first actor). This may be achieved by storing a large database of lighting models, each associated with a different user and by comparing the target image with the database to find either the best fitting lighting model or a “morphable lighting model” which can be created from the database and the best-fitting linear combination of identities used to approximate the identity of the second actor in the target image.

Embodiments have been described above for generating a target video sequence from a source appearance model and a single image of the target. In these embodiments, the appearance parameters derived from the source video sequence were used to drive a target appearance model that was generated from the source appearance model and the target image. This technique works well where the colour of the first actor is similar to that of the second actor. However, sometimes this is not the case and as a modification to these embodiments, the change in texture values from the mean texture may be translated into a change in brightness rather than a change in individual red, green and blue values. This technique can then be used to animate, for example, an image of a polar bear from a video sequence of a human being.

Further, in all of the embodiments described above, the texture modes of variation (defined by the matrices Qᵣ, Q_{g} and Q_{b}) relate to a simple difference in texture values from a reference texture (the mean red, green or blue level vector) through the corresponding texture parameters (pᵣ, p_{g} and p_{b}). As an alternative, the texture modes may be arranged to correspond to the ratio in intensity values to the reference texture. In particular, in the first embodiment, a principle component analysis of the red, green and blue level vectors was carried out on the pixel data sampled from the example images directly. In this alternative embodiment, the mean vector for each colour level is first found and then the raw sampled colour vectors are then replaced with a ratio vector formed by taking the per element ratio to the mean vector. For example, first the mean red level vector of all the sampled red level vectors is computed. Then each element in each sampled red level vector is replaced by the ratio of that element to the corresponding element in the mean red level vector. Finally, an Eigenvector analysis of the red ratio vectors is carried out. This results in the following texture model:

rⁱ=\overline{r}{Q′ᵣ^{T} P′ᵣⁱ} (30)

where Q′^{T} is the new red level model found by carrying out the Eigenvector analysis of the example ratio images and p′ⁱᵣ are the red level parameters with this new model; and the curly brackets illustrate that it is an element by element multiplication as opposed to a vector multiplication as discussed above. The advantage of using ratios for the texture is that it correctly decouples the underlying albedo from changes due to shape and lighting. This means that albedo features such as a mole or a scar will not appear in the texture variation model for the target appearance model and will thus not appear in the target video sequence even though they are present in the source video sequence.

In the above embodiments, an appearance model which modelled the entire shape and colour of a person's face was described. In an alternative embodiment, separate appearance models or just separate colour models may be used for different parts of the face. For example, separate colour models may be used for the eyes, mouth and the rest of the face region. These separate appearance models may be arranged in a “hierarchical manner” in which the parameters output from one model are input to another model or they may be arranged in a segmented manner so that each model generates directly pixel values from the corresponding appearance parameters and the pixel values are then “stitched” together to generate the animated video frame.

As those skilled in the art will appreciate, one of the advantages of the embodiment described above is that it can be used to reduce the amount of data that needs to be transmitted over a network. For example, in a video-phone application or the like, if the appearance model of a user has already been transmitted to a receiver over the telephone line or over the Internet, it is possible to change the identity associated with that appearance model simply by transmitting a new reference shape and reference texture and using these to change the previously transmitted appearance model in the manner discussed above.

Video Communication System

An embodiment will now be described with reference to FIGS. 19 and 20 which illustrates how such a low resolution to high resolution system may be used in a video communication system. As shown in FIG. 8a, the system includes a video camera 101 which generates sequential source images of a user which are fed to a transmitter unit 103. As will be explained in more detail below, the transmitter unit 103 then generates a set of pose and appearance parameters representative of the pose and appearance of the user within each frame of the received video signal and transmits them through a transmission channel 105 to a receiver unit 107. The transmission channel 105 may include the public telephone network, a mobile telephone network, the Internet or the like. The receiver unit 107 then receives the sets of pose and appearance parameters and regenerates a high resolution version of the video signal generated by the camera 101 which it outputs to a display 109.

As shown in FIG. 19a, the camera 101 includes optics 111 which focus light from the user onto a CCD chip 113 which in turn generates the corresponding video signals. The camera 101 also includes a microphone 114 which generates audio signals time synchronised to the video signals. As shown, the video signals are passed to the tracker unit 33 within the transmitter 103 and the audio signals are passed to the encoder unit 115. Referring to FIG. 20a, the tracker unit 33 receives, in step s41, the source video sequence and tracks the facial movements of the user within the sequence to generate, in step s42, pose and appearance parameters for the source video sequence. The pose and appearance parameters are then passed to the identity shift unit 41 which transforms the pose and appearance parameters for use with the high resolution target appearance model 43 in the manner described above. In this embodiment, the identity shift unit 41 does not modify the appearance parameters in order to change the identity of the user but simply modifies them so that they can be used with the high resolution target appearance model 43, to generate a high resolution version of the source image. The modified appearance parameters are then passed to the encoder unit 115.

In this embodiment, however, before the encoder unit 115 encodes the appearance parameters, it encodes, in step s45, the high resolution target appearance model for transmission to the receiver unit 107. The encoder unit 115 then encodes, in step s47, the sequence of pose and appearance parameters for the video sequence together with the corresponding audio signals. The encoded target appearance model is then transmitted, in step s49, through the transmission channel 105 to the receiver unit 107. Then, in step s51, the transmitter unit 103 transmits the encoded appearance parameters and the encoded audio signal to the receiver unit 107. In this embodiment, the audio signals are encoded using a CELP encoding technique and the encoded CELP parameters are transmitted in an interleaved manner with the encoded pose and appearance parameters. If the video data is being transmitted over the Internet then the packets of pose and appearance parameters and the packets of audio data are preferably time stamped so that the time synchronisation between the video frames and the audio can be more easily preserved.

As shown in FIG. 19a, the data received by the receiver unit 107 is input to a decoder unit 117 which decodes the transmitted data. In particular, initially the receiver unit 107 receives and decodes, in step s53, the transmitted target appearance model 43 which it then stores for use by the player unit 45. Once the target appearance model has been received and decoded the receiver unit 107 receives and decodes, in step s55, the encoded pose and appearance parameters and audio signals. The decoded pose and appearance parameters are then passed to the player unit 45 which generates, in step s57, a sequence of video frames corresponding to the sequence of received pose and appearance parameters using the decoded target appearance model. The generated video frames are then output, in step s59, to a display unit 109 where the regenerated high resolution image data is displayed to the user at the receiver terminal. The decoded audio signals output by the decoder unit 117 are passed to an audio drive unit 119 which outputs, in step s61, the decoded audio signals to a loudspeaker 121. The operation of the player unit 45 and the audio drive unit 119 are arranged so that images displayed on the display unit 109 are time synchronised with the appropriate audio signals output by the loudspeaker 121.

The general format of the packets is shown in FIG. 19b. As shown, each packet includes a header portion 121 and a data portion 123. The header portion identifies the size and type of the packet. This makes the data format easily extendible in a forwards and backwards compatible way. For example, if an old player unit 45 is used on a new data stream, it may encounter packets that it does not recognise. In this case, the old player can simply ignore those packets and still have a chance of processing the other packets. The header in each packet includes 16 bits (bit 0 to bit 15) for identifying the size of the packet. If bit 15 is set to 0, the size defined by the other 15 bits is the size of the packet in bytes. If, on the other hand, bit 15 is set to 1, then the remaining bits represent the size of the packet in 32 k blocks. In this embodiment, the transmitter unit can transmit six different types of packets (illustrated in FIG. 19c). These include:

1. Version packet 125—the first packet sent in a stream is the version packet. The number defined in the version packet is an integer and is currently set at the number 3. This number is not expected to change due to the extendible nature of the packet system.

2. Information Packet 127—the next packet to be transmitted is an information packet which includes a sync byte; a byte identifying the average samples (or frames) per second of video; data identifying the number of shorts of parameter data for animating each sample of video short; a byte identifying the number of audio samples per second; a byte identifying the number of bytes of data per sample of audio; and a bit identifying whether or not the audio is compressed. Currently, this bit is set at 0 for uncompressed audio and 1 for audio compressed at 4800 bits per second.

3. Audio Packet 129—for uncompressed audio, each packet contains one second worth of audio data. For 4,800 bits per second compressed audio, each packet contains 30 milliseconds worth of data, which is 18 bytes.

4. Video packet 131—Appearance parameter data for animating a single sample of video.

5. Super-audio packet 133—this is a concatenated set of data from normal audio packets 129. In this embodiment, the player determines the number of audio packets in the super-audio packet by its size.

6. Super-video packet 135—this is a concatenated set of data from normal video packets 131. In this embodiment, the player unit 45 determines the number of video packets by the size of the super-video packet.

In this embodiment, the transmitted audio and video packets are mixed into the transmitted steam in time order, with the earliest packets being transmitted first. Information packets are also embedded within the stream at regular intervals (e.g. every ten seconds). As a result, users receiving the stream after it has begun can search for the next information packet and then play the streamed video from that position onwards in real time.

In addition to the above packets, a copyright packet may be included having a predetermined form. This copyright packet can then be used to control whether or not the player unit plays the streamed data. In particular, if the copyright packets are not present, then the player unit 45 may be configured so that it does not play the stream data.

As those skilled in the art will appreciate, the transmitted video and audio data may be transmitted to the receiver through free space. Alternatively, it may be transmitted through a computer network, such as the Internet or through a telecommunications network (such as the PSTN or a cellular network). In these cases, since there is usually a narrow bandwidth link connecting the transmitter and/or the receiver to the Internet/telephone network, the target appearance models are preferably stored centrally within a server on the Internet/telephone network so that when a video communication link is established, the target appearance model only has to be transmitted over one narrow bandwidth link. As those skilled in the art will appreciate, in such an embodiment, when a user wishes to initiate a video communication with a remote receiver, it also need to transmit a request to the server which stores the target appearance model so that it can be downloaded to the appropriate receiver unit. This must happen before the video and audio data can be played at the receiver unit.

In addition to the above scenario, the transmitter unit may form part of a web site such that when a user logs on to the web site, an appropriate appearance model is downloaded to the user's computer and then the appropriate video and audio data is streamed to the user's terminal to drive the appearance model. In this case, since the streamed video and audio data may be dependent upon feedback provided by the user (e.g. the user clicking on a link for product information), the appearance model may not be constantly driven with appropriate audio and video data. In this case, the appearance model is preferably driven by video parameters which cause the displayed face or character to move. This can be achieved by driving the appearance model with sets of appearance parameters which deviate from the mean set of appearance parameters by a small amount. The sets of appearance parameters that are used may be predetermined or they may be generated in an appropriate random fashion. This gives the illusion that the model has not “frozen” and is still being animated.

A description will now be given with reference to FIG. 21a of the preferred way in which the encoder unit 115 shown in FIG. 19a encodes the target appearance model 43 for transmission to the receiver unit 107. A similar encoding technique would preferably be performed by the central server in the alternative embodiments discussed above. A description will then be given, with reference to FIG. 21b, of the way in which the decoder unit 117 regenerates the target appearance model 43 from the received encoded data.

Initially, in step s71, the encoder unit 115 decomposes the target appearance model 43 into the shape (\hat{Q}ₛ^{trgt}) and colour models (Qᵣ^{trgt}, Q_{g}^{trgt} and Q_{b}^{trgt}). Then, in step s73, the encoder unit 115 generates shape warped colour images for each red, green and blue mode of variation. In particular, shape warped red, green and blue images are generated using equations (6) above for each of the following vectors of colour parameters:

$${p}_{r}^{i} ; {p}_{g}^{i} ; {p}_{b}^{i} = ( \begin{matrix}1 \\ 0 \\ 0 \\ ⋮ \\ 0\end{matrix} ) ; ( \begin{matrix}0 \\ 1 \\ 0 \\ ⋮ \\ 0\end{matrix} ) ; ( \begin{matrix}0 \\ 0 \\ 1 \\ ⋮ \\ 0\end{matrix} ) ; … ( \begin{matrix}0 \\ 0 \\ 0 \\ ⋮ \\ 1\end{matrix} ) \qquad ( 31 )$$

(although the mean vectors used in equation (6) may be ignored if desired). These shape warped images and the mean colour images (\overline{r}, \overline{g} and \overline{b}) are then compressed, in step s75, using a standard image compression algorithm, such as JPEG. However, as those skilled in the art will appreciate, prior to compression using the JPEG algorithm, the shape warped images and the mean colour images must be composited into a rectangular reference frame, otherwise the JPEG algorithm will not work. Since all the shape normalised images have the same shape, they are composited into the same position in the rectangular reference frame. This position is determined by a template image which, in this embodiment is generated directly from the reference shape (schematically illustrated in FIG. 4), and which contains 1's and 0's, with the 1's in the template image corresponding to background pixels and the 0's in the template image corresponding to image pixels. This template image must also be transmitted to the receiver unit 107 and is compressed, in this embodiment, using a run-length encoding technique. The encoder unit 115 then outputs, in step s77, the shape model (\hat{Q}ₛ^{trgt}), the appearance model ((Fₐ^{trgt})^{T}), the mean shape vector (\overline{x}^{trgt}) and the thus compressed images for transmission through the transmission channel 105 to the receiver unit 107.

Referring to FIG. 21b, at the receiver unit 107, the decoder unit 117 decompresses, in step s81, the JPEG images, the mean colour images and the compressed template image. The processing then proceeds to step s83 where the decompressed JPEG images are sampled to recover the shape warped colour vectors (rⁱ, gⁱ and bⁱ) using the decompressed template image to identify the pixels to be sampled. Because of the choice of the colour parameter vectors used to generate these shape warped colour images (see (20) above), the colour models (Qᵣ^{trgt}, Q_{g}^{trgt} and Q_{b}^{trgt}) can then be reconstructed by stacking the corresponding shape warped colour vectors together. As shown in FIG. 10b, this stacking of the shape free colour vectors is performed in step s85. The processing then proceeds to step s87 where the recovered shape and colour models are combined to regenerate the target appearance model 43.

In this embodiment, with this preferred encoding technique, the colour models are transmitted to the receiver unit approximately ten times more efficiently than they would if the colour models were simply transmitted on their own. This is because, each colour model used in this embodiment is typically a thirty thousand by eight matrix and each element of each matrix requires three bytes. Therefore, the transmitter unit 103 would have to transmit about 720 kilobytes of data to transmit the colour model matrixes in uncompressed form. Instead, by generating the shape warped colour images described above and encoding them using a standard image encoding technique and transmitting the encoded images, the amount of data required to transmit the colour models is only about 70 kilobytes.

Image Stabilisation

In the above embodiment, the camera used may form part of a hand held device. In this case, it is likely that there will be some camera shake and it will be difficult for the user to hold the camera still to keep themselves in frame. This may be solved by increasing the field of view of the camera. However, this will reduce the size of the user in the frame and will make the image more shaky. This problem can be overcome using the tracker unit as shown in FIG. 19. In particular, by tracking the user's face within the video signal from the camera, the face can be automatically framed so that it appears full frame at the receiving end. Camera shake will also be eliminated by this process. As those skilled in the art will appreciate, this embodiment can be combined with the image communication embodiment described above or it may be used separately. The advantage of combining this idea with the communication system described above is that if the user's face is small in the original camera image, then it will inevitably be low resolution. Therefore, the system above can be used to restore full image quality.

Manual Parameter Transformation Determination

In the first embodiment, a source appearance model and a target appearance model were initially calculated during a training routine. These models were then used in automatically converting a source video sequence to a target video sequence. In doing this, a set of appearance parameters for each frame in the source video sequence was calculated and then transformed using a predetermined transformation matrix (Rₐ) and offset vector (rₐ) derived from the source and target appearance models. In some cases, the determined matrix (Rₐ) and offset vector (rₐ) will not provide an accurate mapping between the appearance of the first and second actors. This is most likely to occur when the appearance of the target object is very different to the appearance of the source object. In this case, the shape transformation matrix (Rₛ) and the shape offset vector (rₛ) generated in the above manner can be modified by providing many examples of source and target shape parameters which (according to the user) correspond to each other, and by manually tweaking the values of the elements of Rₛ and rₛ until they accurately reflect the transformation required between the corresponding sets of source and target shape parameters. The thus determined shape transformation matrix and offset vector can then be used to determine the appropriate appearance transformation matrix Rₐ and offset vector rₐ.

Alternatively still, the appearance transformation matrix (Rₐ) and offset vector (rₐ) can be determined solely by analysing the relationship between corresponding sets of source and target appearance parameters. For example, the following source appearance parameters together with the corresponding target appearance parameters may be applied to equation (24) (where Rₐ and rₐ are unknown), which can then be solved for the unknowns of Rₐ and rₐ:

$${p}_{a}^{srce} = ( \begin{matrix}0 \\ 0 \\ 0 \\ ⋮ \\ 0\end{matrix} ) ; ( \begin{matrix}1 \\ 0 \\ 0 \\ ⋮ \\ 0\end{matrix} ) ; ( \begin{matrix}0 \\ 1 \\ 0 \\ ⋮ \\ 0\end{matrix} ) ; ( \begin{matrix}0 \\ 0 \\ 1 \\ ⋮ \\ 0\end{matrix} ) ; … ( \begin{matrix}0 \\ 0 \\ 0 \\ ⋮ \\ 1\end{matrix} ) \qquad ( 32 )$$

Alternatively, a similar analysis could be performed on corresponding sets of source and target shape parameters, to determine the shape transformation matrix Rₛ and offset vector rₛ. Again, the thus determined shape transformation matrix and offset vector can then be used to determine the appropriate appearance transformation matrix Rₐ and offset vector rₐ.

As those skilled in the art will appreciate, there are various techniques for generating sets of source and target appearance or shape parameters which correspond to each other. For example, a set of source appearance parameters may be provided together with the corresponding source images and the user may manipulate the target appearance parameters until the corresponding target image corresponds, in the desired manner, to the source image. Alternatively, the target images may be manipulated so that they correspond to the source images. This may be achieved by actively manipulating the subject in the target image. Alternatively, the target images may be manipulated through suitable editing operations using an image editing system. Alternatively still, if a gallery of target images is provided, then this can be searched to find target images which correspond in the desired way to the source images.

Other Modifications

In the above embodiments, the appearance models that were used were generated from a principal component analysis of a set of training images. As those skilled in the art will appreciate, these results apply to any model which can be parameterised by a set of continuous variables. For example, vector quantisation and wavelet techniques can be used.

In the above embodiments, the shape parameters and the colour parameters were combined to generate the appearance parameters. This is not essential. Separate shape and colour parameters may be used. Further, if the training images are black and white, then the texture parameters may represent the grey level in the images rather than the red, green and blue levels. Further, instead of modelling red, green and blue values, the colour may be represented by chrominance and luminance components or by hue, saturation and value components.

In the above embodiments, the models used were two dimensional models. The above embodiments could be adapted to work with 3D modelling techniques and animations. In such an embodiment, the shape model would model a three dimensional mesh of landmark points over the training models. The three dimensional training examples may be obtained using a three dimensional scanner or using one or more stereo pairs of cameras.

In the above embodiment, a source video sequence was modified to generate a target video sequence. As those skilled in the art will appreciate, the above processing technique could be used to modify a single source image. In the above embodiments, the first and second actors were both human. As those skilled in the art will appreciate, the technique could be used to animate non-human characters. In this case, since the shape of the non-human character may be very different to that of a human, movement in the human face may not exactly correspond to that of the non-human character. For example if the character to be animated is the front of a car and an animated mouth is provided on the car, then there may not be direct correspondence between movement of the human mouth and movement of the animated car mouth. This can be compensated by applying different weights to the source shape parameters in the identity shift unit. This can be done by modifying the elements of the S matrix in equation (18) to include the appropriate weights. Again, these weights can be determined by manually varying the weights during a training period until the desired mapping has been determined.

Further, whilst the above embodiment modelled the entire heads of the actors, the appearance models may be used to model just part of the actor's face, such as the actor's lips. Such an embodiment could be used in film dubbing applications in order to synchronise lip movements with the dubbed sound. This animation technique might also be used to give animals and other objects human-like characteristics. As those skilled in the art will appreciate, to do this, the position of the various landmark points on the faces must be mapped to (user defined) corresponding locations on the target object.

In the above embodiment, during the automatic generation of the appearance parameters for each source video frame and in particular during the iterative updating of those appearance parameters, the error between the input image and the model image was generated using the appearance model. Since this iterative technique still requires a relatively accurate initial estimate for the appearance parameters, it is possible to initially perform the iterations using lower resolution images and, once convergence has been reached for the lower resolutions, to then increase the resolution of the images and to repeat the iterations for the higher resolutions. In such an embodiment, separate active matrices would be required for each of the resolutions.

In the above embodiment, a linear transformation was determined for transforming sets of source appearance parameters into corresponding sets of target appearance parameters. Various techniques were described for deriving the appropriate transformation matrix. As those skilled in the art will appreciate, other types of transformation between source appearance parameters and target appearance parameters may be derived. For example, non-linear transformations may be used. One type of non-linear transformation that may be used is the use of a neural network. In this case, during training, corresponding sets of source and target appearance parameters would be applied to the neural network to train it. Suitable training techniques such as back propagation could be used. However, the linear transformation matrix described above is currently preferred because of its simplicity and because of its ease of derivation.

1. An image processing apparatus comprising:
means for storing source model data defining a function which relates a set of source parameters to image data defining an appearance of a source object;
means for storing target model data defining a function which relates a set of target parameters to image data defining an appearance of a target object;
means for storing transformation data defining a transformation which relates source parameters to target parameters;
means for receiving image data defining an appearance of the source object;
means for determining a set of source parameters for the source object in the received image using the received image data and the source model data;
means for determining a set of target parameters corresponding to the determined set of source parameters using the transformation data and the determined set of source parameters; and
means for determining image data defining an appearance of the target object using said determined set of target parameters and said target model data.

2. An apparatus according to claim 1, wherein said source model defines a linear function between said set of source parameters and said image data defining the appearance of the source object.

3. An apparatus according to claim 1 or 2, wherein said target model defines a linear function between said set of target parameters and said image data defining the appearance of the target object.

4. An apparatus according to any preceding claim, wherein said transformation data defines a linear function between said set of source parameters and said set of target parameters.

5. An apparatus according to claim 4, wherein said linear transformation is such that one or more of said target parameters corresponds to a linear weighted combination of said source parameters.

6. An apparatus according to claim 4 or 5, wherein said transformation data defines the following transformation:
p^{trgt}=R·p^{srce}+r (19)
where p^{srce} is the set of source parameters; p^{trgt} is the set of target parameters; R is a transformation matrix; and r is a vector of offsets.

7. An apparatus according to claim 6, wherein R is determined from said source model data and said target model data.

8. An apparatus according to claim 7, wherein R is determined automatically.

9. An apparatus according to claim 6, wherein R and r are determined experimentally in advance by providing a plurality of corresponding sets of source parameters and target parameters.

10. An apparatus according to claim 9, wherein said corresponding sets of source parameters and target parameters include the following sets of source parameters:
$${p}^{srce} = ( \begin{matrix}0 \\ 0 \\ 0 \\ ⋮ \\ 0\end{matrix} ) ; ( \begin{matrix}1 \\ 0 \\ 0 \\ ⋮ \\ 0\end{matrix} ) ; ( \begin{matrix}0 \\ 1 \\ 0 \\ ⋮ \\ 0\end{matrix} ) ; ( \begin{matrix}0 \\ 0 \\ 1 \\ ⋮ \\ 0\end{matrix} ) ; … ( \begin{matrix}0 \\ 0 \\ 0 \\ ⋮ \\ 1\end{matrix} )$$

11. An apparatus according to any of claims 1 to 3, wherein said transformation data defines a non-linear transformation between said source parameters and said target parameters.

12. An apparatus according to claim 11, wherein said transformation data defines a neural network which relates said source parameters to said target parameters.

13. An apparatus according to any preceding claim, wherein said source model data and said target model data define the shape of the source object and the target object respectively.

14. An apparatus according to any preceding claim, wherein said source model data and said target model data define the shape and texture of the source object and the target object respectively.

15. An apparatus according to any preceding claim, wherein said source model data and said target model data define the shape and colour of the source object and the target object respectively.

16. An apparatus according to any preceding claim, wherein said source model data and said target model data define the appearance of the source object and the target object at different resolutions.

17. An apparatus according to claim 16, wherein said target model data defines the appearance of the target object to a greater resolution than the source model data defines the appearance of the source object.

18. An apparatus according to any preceding claim, wherein said source object and said target object are the same object.

19. An apparatus according to any of claims 1 to 17, wherein said source object comprises a first human face and said target object comprises a second human face.

20. An apparatus according to any preceding claim, wherein said source object and said target object are deformable objects.

21. An apparatus according to any preceding claim, wherein at least one of said source object and said target object comprises a human face.

22. An apparatus according to any preceding claim, wherein said receiving means is operable to receive a sequence of images of the source object and wherein said apparatus is operable to determine corresponding images of said target object using said received sequence of source images and said stored data.

23. An apparatus according to any preceding claim, wherein said source model data is determined in advance from a plurality of training images of the source object.

24. An apparatus according to claim 23, wherein said source model data is determined using a principal component analysis on the training images to identify the main modes of variation of the source object in the training images.

25. An apparatus according to claim 23 or 24, wherein said target model data is determined in advance from a plurality of training images of the target object.

26. An apparatus according to claim 25, wherein said target model data is determined using a principal component analysis on the training images to identify the main modes of variation of the target object in the training images.

27. An apparatus according to claim 25 or 26, wherein said source object and said target object are for the same person, wherein said source model data is determined from general training images of the person and wherein said target model data is determined from selected training images of the person.

28. An image processing apparatus comprising:
means for storing source model data defining a function which relates a set of source parameters to a source set of locations which identify the relative positions of a plurality of predetermined points on a source object;
means for storing target model data defining a function which relates a set of target parameters to a target set of locations which identify the relative positions of a plurality of predetermined points on a target object;
means for storing transformation data defining a transformation which relates source parameters to target parameters;
means for receiving image data for an image of the source object;
means for determining said source set of locations for the source object in the received image;
means for determining a set of source parameters for the source object in the received image using the determined source set of locations and the source model data;
means for determining a set of target parameters corresponding to the determined set of source parameters using the transformation data and the determined set of source parameters;
means for determining a target set of locations using said determined set of target parameters and said target model data; and
means for determining image data of said target object using said determined target set of locations.

29. An apparatus according to claim 28, wherein said source model data models the two dimensional shape of the source object by identifying the relative positions of said predetermined points in a predetermined plane.

30. An apparatus according to claim 28 or 29, wherein said target model data models the two dimensional shape of the target object by identifying the relative positions of said predetermined points in a predetermined plane.

31. An apparatus according to any of claims 28 to 30, wherein said source model data models the three dimensional shape of the source object by identifying the relative positions of said predetermined points in a three dimensional space.

32. An apparatus according to any of claims 28 to 31, wherein said target model data models the three dimensional shape of the target object by identifying the relative positions of said predetermined points in a three dimensional space.

33. A camera comprising:
means for storing first model data defining a function which relates a set of first parameters to image data of said object at a first resolution;
means for storing second model data defining a function which relates a set of second parameters to image data of said object at a second resolution;
means for storing transformation data defining a transformation which relates said first parameters to said second parameters;
means for sensing light from the object and for generating image data at said first resolution therefor;
means for determining a set of first parameters for the object using the sensed image data and the first model data;
means for determining a set of second parameters corresponding to the determined set of first parameters using the transformation data and the determined set of first parameters; and
means for determining image data of the object at said second resolution using said determined set of second parameters and said second model data.

34. A camera according to claim 33, wherein said first resolution is lower than said second resolution.

35. A camera according to claim 33 or 34, wherein said first model data is determined in advance from a plurality of training images of the object at said first resolution.

36. A camera according to any of claims 33 to 35, wherein said second model data is determined in advance from a plurality of training images of the object at said second resolution.

37. An apparatus for generating an appearance model for an object, the appearance model defining a function which relates a set of parameters to pixel values which define an appearance of the object, the apparatus comprising:
means for receiving plural training pixel images of the object having different appearances;
means for sampling pixel values at predetermined points over each of the training images to generate a respective plurality of sets of corresponding pixel values for the training images; and
means for processing the sets of corresponding pixel values to determine said appearance model;
wherein said object includes one or more features of interest and wherein said sampling means is operable to take more samples of pixel values over said one or more features of interest than over other parts of the object.

38. An apparatus according to claim 37, wherein said object is a face and wherein said one or more features of interest include the eyes and/or mouth of the face.

39. An apparatus according to claim 37 or 38, further comprising means for warping the training images in order to increase the size of said one or more features relative to the rest of the object and wherein said sampling means is operable to sample the warped images of the object at a substantially constant sampling density.

40. An apparatus for determining a set of parameter values representative of the appearance of an object within an input image, the apparatus comprising:
means for storing an appearance model generated using an apparatus according to any of claims 37 to 39;
means for receiving the input image of the object;
means for sampling pixel values at predetermined points over the received image to generate a set of pixel values representative of the appearance of the object in the received image; and
means for generating a set of parameters for the object in the received image using said appearance model and said sampled pixel values;
wherein said sampling means is operable to take more samples of pixel values over said one or more features of interest in the received image than over other parts of the object.

41. An apparatus for generating an appearance model for an object, the appearance model defining a function which relates a set of parameters to pixel values which define an appearance of the object, the apparatus comprising:
means for receiving plural training pixel images of the object having different appearances;
means for identifying the location within each training image of a plurality of predetermined points on the object, the predetermined points identifying the outline of the object and the locations of one or more features of interest on the object;
means for warping each training image so that the determined locations of said predetermined points are warped to the locations of the corresponding points in a reference image of the object;
means for sampling pixel values of each of the warped training images to generate a respective plurality of sets of corresponding pixel values for the training images; and
means for processing the sets of corresponding pixel values to determine said appearance model;
wherein said one or more features of interest on the object are enlarged in said reference image of the object relative to other parts of the object.

42. An apparatus according to claim 41, wherein said sampling means is operable to sample said warped image at a substantially constant pixel density.

43. An apparatus for determining a set of parameter values representative of the appearance of an object within an input image, the apparatus comprising:
means for storing an appearance model generated using an apparatus according to claim 41 or 42;
means for receiving the input image of the object;
means for identifying the location within the input image of said plurality of predetermined points on the object;
means for warping the input image so that the determined locations of said predetermined points are warped to the locations of the corresponding points in the reference image of the object;
means for sampling pixel values of the warped input image to generate a set of pixel values for the input image; and
means for determining said set of parameter values for the input image using said sampled pixel values for the input image and said appearance model.

44. An apparatus according to claim 43, wherein said sampling means is operable to sample said warped input image at a substantially constant pixel density.

45. A video communication system comprising:
a transmitter and a receiver;
wherein the transmitter comprises:
means for storing source model data defining a function which relates a set of source parameters to image data defining an appearance of a source object;
means for storing target model data defining a function which relates a set of target parameters to image data defining an appearance of a target object;
means for storing transformation data defining a transformation which relates source parameters to target parameters;
means for receiving current image data defining a current appearance of the source object;
means for determining a set of source parameters for the source object in the current image data using the current image data and the source model data;
means for determining a set of target parameters corresponding to the determined set of source parameters using the transformation data and the determined set of source parameters; and
means for transmitting the target model data and the determined target parameters; and
wherein the receiver comprises:
means for receiving the transmitted target model data and said target parameters; and
means for determining image data defining an appearance of the target object using the determined set of target parameters and said target model data.

46. A system according to claim 45, wherein said transmitter further comprises means for encoding said target model data for transmission to said receiver by said transmitting means.

47. A system according to claim 46, wherein said encoding means is operable to encode said target model data by applying predetermined sets of target parameters to said target model data to derive corresponding image data for each of the predetermined sets of target parameters and means for compressing said determined image data generated from the predetermined sets of target parameters.

48. A system according to claim 47, wherein said receiver comprises means for decompressing said compressed image data and means for resynthesising said target model data using said decompressed images and the predetermined sets of target parameters.

49. A communication system according to claim 48, wherein said predetermined sets of target parameters include the following:
$$( \begin{matrix}1 \\ 0 \\ 0 \\ ⋮ \\ 0\end{matrix} ) ; ( \begin{matrix}0 \\ 1 \\ 0 \\ ⋮ \\ 0\end{matrix} ) ; ( \begin{matrix}0 \\ 0 \\ 1 \\ ⋮ \\ 0\end{matrix} ) ; … ( \begin{matrix}0 \\ 0 \\ 0 \\ ⋮ \\ 1\end{matrix} ) \qquad 98$$

50. A communication system according to any of claims 45 to 49, wherein said receiving means of said transmitter is operable to receive a sequence of images of the source object, wherein said transmitter is operable to determine corresponding target parameters for one or more of the received images of the source object and wherein said transmission means is operable to transmit sets of target parameter values to said receiver for said one or more of said images in the sequence.

51. A communication system according to claim 50, wherein said transmitter is operable to determine corresponding target parameters for each of the received images of the source object and wherein said transmission means is operable to transmit sets of target parameter values to said receiver for each image in the sequence.

52. A system according to claim 50 or 51, wherein said transmitter further comprises means for receiving audio signals corresponding to said sequence of images and wherein said transmitter is operable to transmit audio data to said receiver together with said target parameters for the sequence of images.

53. A system according to claim 52, wherein said transmitting means is operable to transmit said sets of target parameters and said audio signals to said receiver in a time interleaved manner.

54. A system according to claim 53, wherein said transmitting means is operable to transmit said target parameters and said audio signals in packets of information.

55. A communication system according to any of claims 45 to 54, wherein said transmitter is operable to transmit said data to said receiver via the Internet.

56. A system according to any of claims 45 to 55, wherein said source model data and said target model data define the appearance of the source object and the target object at difference resolutions.

57. A communication system according to claim 56, wherein said target model data define the appearance of the target object to a greater resolution than the source model data defines the appearance of the source object.

58. An image communication system comprising:
a transmitter and a receiver;
wherein the transmitter comprises:
means for storing transmitter model data defining a function which relates a set of parameters to image data defining an appearance of an object;
means for receiving image data defining an appearance of the object;
means for determining a set of parameters for the object in the received image using the received image data and the model data; and
means for transmitting the determined set of parameter values to said receiver;
wherein the receiver comprises:
means for storing receiver model data defining a function which relates a set of parameters to image data defining an appearance of the object;
means for receiving transmitted sets of parameters; and
means for generating image data defining an appearance of the object using said received set of parameters and said model data.

59. A communication system according to claim 58, further comprising means for transforming said set of parameters in accordance with a predetermined transformation.

60. A system according to claim 59, wherein said predetermined transformation is operable to alter the identity of the object.

61. A system according to claim 59 or 60, wherein said transmitter model data relates said set of parameters to image data having a first resolution and wherein said receiver model data is operable to define a function which relates said parameters to image data having a second different resolution and wherein said transformation means is operable to transform the parameters for the transmitter model data into parameters for use with the receiver model data.

62. A system according to claim 59, 60 or 61, wherein said transformation means is located within said transmitter.

63. A system according to claim 59, 60 or 61, wherein transformation means is located within said receiver.

64. A system according to claim 59, 60 or 61, wherein said transmitter is operable to transmit said parameters to said receiver via at least one intermediate processing node and wherein said transformation means is provided within said intermediate processing node.

65. A communication system according to any of claims 58 to 64, further comprising means for storing said receiver model data and means for transmitting said stored receiver model data to said receiver.

66. A system according to claim 65, wherein said means for storing said receiver model data and said means for transmitting said receiver model data to said receiver are located within said transmitter.

67. A system according to claim 65, wherein said transmitter is operable to transmit said set of parameters to said receiver via a computer network and wherein said means for storing said receiver model data and said means for transmitting said receiver model data to said receiver are located within said computer network.

68. A system according to any of claims 65 to 67, wherein said means for transmitting said receiver model data includes means for encoding said receiver model data.

69. A system according to claim 68, wherein said encoding means is operable to encode said receiver model data by applying predetermined sets of parameters to said receiver model data to derive corresponding image data for each of the predetermined sets of parameters and means for compressing the determined image data generated from the predetermined sets of parameters.

70. A system according to claim 69, wherein said receiver comprises means for decompressing said compressed image data and means for resynthesising said receiver model data using said decompressed images and the predetermined sets of parameters.

71. A system according to claim 69, wherein said image data determined for each of the predetermined sets of parameters is composited within a rectangular frame and wherein a template image is used to identify pixels within the composited image which relate to background pixels and those which relate to the image data generated by said target parameters; wherein said transmitting means is operable to transmit said template image to said receiver and wherein said receiver is operable to resynthesise said receiver model data using said template image.

72. A system according to claim 71, wherein said template image comprises a two dimensional array of pixel values corresponding to a binary one or a binary zero, with a binary one representing background pixels and a binary zero representing image data generated by the target parameters.

73. A communication system according to any of claims 58 to 72, wherein said receiving means of said transmitter is operable to receive a sequence of images of the object, wherein said transmitter is operable to determine corresponding parameters for each of said received images of the object and wherein said transmitter means is operable to transmit sets of parameter values to said receiver for each image in the sequence.

74. A system according to claim 73, wherein said transmitter further comprises means for receiving audio signals corresponding to said sequence of images and wherein said transmitter is operable to transmit audio data to said receiver together with said parameters for the sequence of images.

75. A system according to claim 74, wherein said transmitting means is operable to transmit said sets of parameters and said audio signals to said receiver in a time interleaved manner.

76. A system according to claim 75, wherein said transmitting means is operable to transmit said parameters and said audio signals in packets of information.

77. A transmitter circuit comprising any of the technical transmitter circuit features of any of claims 45 to 76.

78. A receiver circuit comprising any of the technical receiver circuit features according to any of claims 45 to 46.

79. A data stream for driving an appearance model which relates a set of parameters to image data, to generate a synthesised image sequence, the data stream comprising: a sequence of data packets including information packets which include data concerning the animated video sequence to be generated; and image data packets including parameter data for driving said appearance model to generate said synthesised image sequence.

80. A data stream according to claim 79, wherein plural information packets are provided in said data stream.

81. A data stream according to 79 or 80, wherein one or more of said image packets include parameter data for plural images of the synthesised image sequence.

82. A data stream according to any of claim 79 to 81, wherein each of said image packets includes time stamp information.

83. A data stream according to any of claims 79 to 82, wherein said stream of data packets include audio packets which comprise audio data for the animated image sequence.

84. A data stream according to claim 83, wherein said audio packets are interleaved with said image packets in said data stream.

85. A data stream according to any of claims 79 to 84, wherein said information packet is repeated at regular intervals within said packet stream.

86. A data stream according to any of claims 79 to 85, wherein said packet stream furthers comprises one or more copyright packets including copyright information.

87. A player unit for generating a synthesised image sequence, comprising:
means for storing an appearance model which relates a set of parameters to image data;
means for receiving a data stream according to any of claims 79 to 86; and
means for generating the synthesised image sequence using the stored appearance model and the image data packets in accordance with the date included within said information packets.

88. A player unit according to claim 87 when dependent upon claim 86, further comprising means for sensing the existence of said one or more copyright packets within said packet stream and means for inhibiting the operation of said image sequence generating means if said sensing means senses that the packet stream does not include said copyright packet.

89. A video camera comprising:
means for storing model data defining a function which relates a set of parameters to image data defining an appearance of an object;
a wide angled lens and a light sensor for imaging a scene including the object and generating a sequence of images of the scene including the object;
means for processing said sequence of images to extract the image data corresponding to the object within each image of the sequence;
means for scaling the extracted image data to generate scaled image data for each image in the sequence;
means for generating sets of parameters for each scaled image using said model data; and
means for outputting said sets of parameters.

90. A camera according to claim 89, further comprising means for generating a synthesised video sequence using said output sets of parameters and said model data.

91. A camera according to claim 89 or 90, further comprising means for transforming the sets of parameters for the object into sets of target parameters and target model data defining a function which relates sets of target parameters to image data defining an appearance of a target object.

92. A camera according to claim 91, wherein said transformation means is operable to alter the identity of the object.

93. A camera according to claim 91 or 92, wherein said target model data is operable to relate said parameters to image data having a higher resolution than the other model data stored in the camera.

94. An apparatus for encoding an appearance model which relates a set of parameters to image data representative the appearance of an object, for transmission over a communication link, the apparatus comprising:
means for applying predetermined sets of parameters to said appearance model to derive corresponding image data for each of the predetermined sets of parameters and means for compressing said determined image data generated from the predetermined sets of target parameters.

95. An apparatus according to claim 94, wherein said derived image data corresponding to the predetermined sets of parameters are composited within a rectangular template image which identifies pixels corresponding to the image data and pixels corresponding to background; and further comprising means for compressing said template image.

96. An apparatus according to claim 95, wherein a common rectangular template image is used for the image data generated by each of the sets of parameters.

97. An apparatus according to claim 95 or 96, wherein said template image is compressed using a first image compression technique and wherein said image data is compressed using a second image compression technique.

98. An apparatus for decoding an appearance model encoded using an apparatus according to any of claims 94 to 97 comprising:
means for receiving the compressed image data;
means for decompressing the compressed image data; and
means for reconstructing the appearance model using the decompressed image data and the predetermined sets of parameters.

99. An apparatus according to any preceding claim, wherein said predetermined sets of parameters include:
$$( \begin{matrix}1 \\ 0 \\ 0 \\ ⋮ \\ 0\end{matrix} ) ; ( \begin{matrix}0 \\ 1 \\ 0 \\ ⋮ \\ 0\end{matrix} ) ; ( \begin{matrix}0 \\ 0 \\ 1 \\ ⋮ \\ 0\end{matrix} ) ; … ( \begin{matrix}0 \\ 0 \\ 0 \\ ⋮ \\ 1\end{matrix} )$$

100. An image processing method comprising the steps of:
receiving image data defining an appearance of a source object;
determining a set of source parameters for the, source object in the received image using the received image data and stored source model data which defines a function which relates a set of source parameters to image data defining an appearance of the source object;
determining a set of target parameters corresponding to the determined set of source parameters using the transformed data and the determined set of source parameters; and
determining image data defining an appearance of the target object using the determined set of target parameters and stored target model data which defines a function that relates a set of target parameters to image data defining appearance of the target object.

101. An image processing method comprising the steps of:
receiving image data for an image of a source object;
determining a source set of locations which identify the relative positions of a plurality of predetermined points on the source subject;
determining a set of source parameters for the source object in the received image using the determined source set of locations and stored source model data which defines a function which relates a set of source parameters to a source set of locations which identify the relative positions of a plurality of predetermined points on the source object;
determining a set of target parameters corresponding to the determined set or source parameters using stored transformation data and a determined set of source parameters;
determining a target set of locations using said determined set of target parameters and stored target model data which defines a function which relates a set of target parameters to a target set of locations which identify the relative positions of a plurality of predetermined points on the target object; and
determining image data of the target object using the determined target set of locations.

102. A method of generating an appearance model for an object, the appearance model defining a function which relates a set of parameters to pixel values which define an appearance of the object, the method comprising the steps of:
receiving plural training images of the object having different appearances;
sampling pixel values at predetermined points over each of the training images to generate a respective plurality of sets of corresponding pixel values for the training images; and
processing the sets of corresponding pixel values to determine said appearance model;
wherein the object includes one or more features of interest and wherein the sampling step takes more samples of pixel values over said one or more features of interest than over other parts of the object.

103. A image communication method comprising:
at a transmitter:
receiving current image data defining a current appearance of a source object;
determining a set of parameters for the object in the received image using the received image data and stored model data that defines a function which relates a set of parameters to image data defining an appearance of the object; and
transmitting the determined set of parameter values to a receiver; and
at the receiver:
receiving transmitted sets of parameters; and
generating image date defining an appearance of the object using the received set of parameters and stored receiver model data that defines a function which relates a set of parameters to image data defining an appearance of the object.

104. Apparatus for providing a user interface for image processing apparatus, the apparatus comprising:
means for causing a display to display on a display screen a first image on which specific positions are marked by landmark points;
means for causing the display to display on the display screen with the first image a second image on which landmark points are provided so as to be positionable by a user;
means for determining when a landmark point on the second image is selected by a user; and
means for visually identifying to the user the landmark point in the first image corresponding to the selected landmark point to assist the user in positioning the selected landmark point.

105. Apparatus according to claim 104, further comprising means for visually identifying the selected landmark point.

106. Apparatus according to claim 104 or 105, wherein the identifying means are arranged to identify a landmark point by highlighting or changing the colour of the landmark point relative to the other landmark points.

107. Apparatus according to any one of claims 104 to 106, further comprising means for moving a selected landmark point in response to a user dragging the selected landmark point and dropping it at a new position.

108. Apparatus according to any one of claims 104 to 106, further comprising means for fixing a landmark point in position.

109. Apparatus according to claim 108, further comprising means for unfixing the position of at least one landmark point.

110. Apparatus according to any one of claims 104 to 109, further comprising means for causing the display to display a description of a landmark point selected by the user.

111. Apparatus according to claim 110, further comprising means for enabling a user to alter the description of a landmark point.

112. Apparatus according to any one of claims 104 to 111, wherein the determining means is arranged to determine that a landmark point has been selected by a user when the user places a cursor over the landmark point.

113. Apparatus according to any one of claims 104 to 112 for use in image processing apparatus in accordance with any one of claims 1 to 32 for enabling input of data to facilitate generation of source or target model data.

114. Apparatus according to any one of claims 104 to 113 for use in image processing apparatus in accordance with any one of claims 37 to 44, wherein the first image is a warped image generated by using apparatus in accordance with any one of claims 37 to 44.

115. Apparatus for providing a user interface for image processing apparatus, the apparatus comprising:
means for causing a display to display on a display screen different images of a first image sequence with each image having specific positions therein marked by landmark points;
means for causing the display to provide on the display screen an error display area for displaying to the user a visual representation of an error value relating to a difference between that image and a reconstructed version of image so as to show to the user how the error varies for different images; and
means for causing a visual representation of an error for an image to be added to the error display area when that image is displayed.

116. Apparatus according to claim 115, wherein the visual representation causing means are arranged to cause the visual representation to be displayed as a graph of error against frame numbers of the images in the image sequence.

117. Apparatus according to claim 115 or 116, further comprising means for causing the display to display a frame number for a displayed image in a frame window.

118. Apparatus according to any one of claims 115 to 117, comprising means for causing the display to display a numerical representation of the error value for a displayed image in an error display window.

119. Apparatus according to any one of claims 115 to 118, comprising means for causing the display to display the one of the images of the image sequence associated with a particular error value when the visual representation of that error value is selected by the user.

120. Apparatus according to any one of claims 115 to 119, comprising means for enabling a user to cause the images of the image sequence to be displayed in at least one of a forward or a reverse order.

121. Apparatus according to any one of claims 115 to 120, comprising means for causing the display to display with the image of the image sequence the corresponding reconstructed image.

122. Apparatus according to any one of claims 115 to 121, comprising means for causing the display to display the image of the image sequence for which the error value is greatest.

123. Apparatus according to any one of claims 15 to 122 for use with image processing apparatus in accordance with any one of claims 1 to 32, wherein the image sequence comprises images of the source object and the reconstructed images are images of the target object.

124. Apparatus for providing a user interface for image processing apparatus, the apparatus being operable in a first mode to provide apparatus in accordance with any one of claims 104 to 114 and in a second mode to provide apparatus in accordance with any one of claims 115 to 123.

125. A method of operating a processor to provide a user interface for image processing apparatus, the method comprising causing the processor to:
cause the display to display on a display screen a first image on which specific positions are marked by landmark points;
cause the display to display on the display screen with the first image a second image on which landmark points are provided to as to be positionable by the user;
determine when a landmark point on the second image has been selected by a user; and
visually identify to the user the landmark point in the first image corresponding to the selected landmark point to assist the user in positioning the selected landmark point.

126. A method of operating a processor, which method comprises causing the processor to:
cause a display to display in succession on a display screen different images of an image sequence with each image having specific positions therein marked by landmark points;
cause the display to provide on the display screen an error display area for displaying to the user a visual representation of an error value relating to a difference between that image and a reconstructed version of that image as to show to the user how the error varies for difference images; and
cause a visual representation of the error value for the image to be added to the error display area when that image is displayed.

127. An apparatus for generating an animated sequence of images of an object from an image of the object, the apparatus comprising:
means for storing model data defining a relationship between a set of parameter values and a set of shape and texture deviations from a set of shape and texture values;
means for receiving the image of the object to be animated;
means for processing the image of the object to obtain shape data defining the shape of the object in the image and texture data defining the texture of the object in the image;
means for receiving a plurality of sets of parameter values representative of an image sequence;
means for determining sets of shape and texture deviations from the received plurality of sets of parameter values and said stored model data;
means for applying each set of determined shape and texture deviations to said obtained shape data and texture data to generate respective modified shape data and texture data for each set; and
means for generating a modified image of the object for each set of deviations from the corresponding modified shape data and texture data to generate said animated sequence of images.

128. An apparatus according to claim 127, wherein said processing means is operable to obtain initial shape data and initial texture data defining the texture of the object in the image and is operable to modify said initial shape and texture data so that the appearance of said object in said image corresponds to a predetermined appearance.

129. An apparatus according to claim 127 or 128, wherein said processing means is operable apply a scale to said shape data and said texture data.

130. An apparatus according to claim 128, wherein said processing means is operable to modify said reference shape and texture so that the expression of the object in the image is similar to the expression of another similar object.

131. The apparatus of claim 130, wherein said model data defines a relationship between said shape and texture deviations from shape and texture values derived from said other object.

132. An apparatus according to any of claims 127 to 131, further comprising means for varying lighting conditions of said object in said image.

133. An apparatus according to any of claims 127 to 132, wherein said deviations relate to a difference in texture from said texture values.

134. An apparatus according to any of claims 127 to 132, wherein said deviations relate to a ratio of the resulting texture values to said set of texture values.

135. An apparatus according to any of claims 127 to 134, wherein said texture data corresponds to the luminance of the object in the image.

136. An apparatus for determining the lighting conditions of an object in an image, comprising:
means for receiving data defining a lighting model for an object under a plurality of different lighting conditions, the lighting model relating lighting conditions to a corresponding image of the object under those lighting conditions;
means for determining an inverse of said lighting model; and
means for applying an image of an object with unknown lighting conditions to said inverse lighting model to determine said unknown lighting conditions.

137. An apparatus according to claim 139, wherein the object in the image of unknown lighting conditions is different to the object associated with said lighting model.

138. An apparatus for changing the lighting conditions of a first object in a first image to correspond to the lighting conditions of a second object in a second image, the apparatus comprising the steps of:
means for receiving data defining a lighting model for a third object under a plurality of different lighting conditions, the lighting model relating lighting conditions to a corresponding image of the third object under those lighting conditions;
means for determining an inverse of said lighting model;
means for applying said first image of said first object to said inverse lighting model to determine the lighting conditions of said first object in said first image;
means for applying said second image of said second object to said inverse lighting model to determine the lighting conditions of said second object in said second image;
means for applying the lighting conditions determined for said first object to said lighting model to generate an image of said third object under the lighting conditions of said first object;
means for determining a ratio image of said first image of said first object and said image of said third object under the lighting conditions of said first object;
means for applying the lighting conditions of said second image to said lighting model to generate an image of said third object under the lighting conditions of said second object; and
means for generating an image of said first object under the lighting conditions of said second object from said ratio image and said image of the third object under the lighting conditions of said second object.

139. A method of determining the lighting conditions of an object in an image, the method comprising the steps of:
receiving data defining a lighting model for an object under a plurality of different lighting conditions, the lighting model relating lighting conditions to a corresponding image of the object under those lighting conditions;
determining an inverse of said lighting model; and
applying an image of an object with unknown lighting conditions to said inverse lighting model to determine said unknown lighting conditions.

140. A method of changing the lighting conditions of a first object in a first image to correspond to the lighting conditions of a second object in a second image, the method comprising the steps of:
receiving data defining a lighting model for a third object under a plurality of different lighting conditions, the lighting model relating lighting conditions to a corresponding image of the third object under those lighting conditions;
determining an inverse of said lighting model;
applying said first image of said first object to said inverse lighting model to determine the lighting conditions of said first object in said first image;
applying said second image of said second object to said inverse lighting model to determine the lighting conditions of said second object in said second image;
applying the lighting conditions determined for said first object to said lighting model to generate an image of said third object under the lighting conditions of said first object;
determining a ratio image of said first image of said first object and said image of said third object under the lighting conditions of said first object;
applying the lighting conditions of said second image to said lighting model to generate an image of said third object under the lighting conditions of said second object; and
generating an image of said first object under the lighting conditions of said second object from said ratio image and said image of the third object under the lighting conditions of said second object.

141. A method of animating a sequence of images of an object from an image of the object, the method comprising the steps of:
storing model data defining a relationship between a set of parameter values and a set of shape and texture deviations from a set of shape and texture values;
receiving the image of the object to be animated;
processing the image of the object to obtain shape data defining the shape of the object in the image and texture data defining the texture of the object in the image;
receiving a plurality of sets of parameter values representative of an image sequence;
determining sets of shape and texture deviations from the received plurality of sets of parameter values and said stored model data;
applying each set of determined shape and texture deviations to said obtained shaped data and texture data to generate respective modified shape data and texture data for each set; and
generating a modified image of the object for each set of deviations from the corresponding modified shape data and texture data to generate said animated sequence of images.

142. A method of adapting a model used for modelling the appearance of a first object to generate an adapted model for modelling the appearance of a second different object, the method comprising the steps of:
receiving an image of the second object;
means for processing the image of the second object to obtain shape data defining the shape of the object in the image and texture data defining the texture of the object in the image; and
modifying said model using said shape and texture data.

143. A computer readable medium storing computer executable process steps for configuring a general purpose processor to become configured as an apparatus or system according to any of claims 1 to 99 or 104 to 138.

144. Computer executable process steps for configuring a general purpose processor to become configured as an apparatus of system according to any of claims 1 to 99 or 104 to 138.
